(19) United States
(12) Patent Application Publication
(10) Pub. No.: US 2022/0300127 A1
(43) Pub. Date: Sep. 22, 2022

(54) COMPUTER-READABLE RECORDING MEDIUM STORING CONVERSATION CONTROL PROGRAM, CONVERSATION CONTROL METHOD, AND INFORMATION PROCESSING DEVICE

(71) Applicant: FUJITSU LIMITED, Kawasaki-shi (JP)

(72) Inventors: SHINJI NARUKAWA, OHTA (JP); Kazuhiro Nakamura, Ota (JP); Yuzo Kurose, Ota (JP)

(73) Assignee: FUJITSU LIMITED, Kawasaki-shi (JP)

(21) Appl. No.: 17/834,630

(22) Filed: Jun. 7, 2022

Related U.S. Application Data
(63) Continuation of application No. PCT/JP2019/050277, filed on Dec. 23, 2019.

(51) Int. Cl. G06F 3/0484; G06F 3/0482

(52) U.S. Cl. CPC G06F 3/0484; G06F 3/0482

(57) ABSTRACT

A recording medium stores a program for causing a computer to execute processing including: receiving a start instruction of a conversation with a chatbot from an information processing terminal, and receiving type information of the information processing terminal and information that specifies an operation time zone in the information processing terminal; when the type information corresponds to a specific information processing terminal, starting the conversation with the chatbot by using the script information determined on the basis of the received information that specifies an operation time zone; and when the type information does not correspond to the specific information processing terminal, displaying information by which at least one of pieces of the script information that respectively corresponds to the plurality of operation time zones is selectable on the information processing terminal, and starting the conversation with the chatbot by using the selected script information.

### CROSS-REFERENCE TO RELATED APPLICATION

This application is a continuation application of International Application PCT/JP2019/050277 filed on Dec. 23, 2019 and designated the U.S., the entire contents of which are incorporated herein by reference.

### FIELD

The embodiment discussed herein is related to a conversation control program, a conversation control method, and an information processing device.

### BACKGROUND

In recent years, digital boards capable of two-way communication linked with chatbots have begun to be used. The digital boards are used, for example, to guide stores and services. Furthermore, the digital boards are installed in highly public places such as airports, stations, government offices, and towns, and are expected to be used by an unspecified number of people.

Japanese Laid-open Patent Publication No. 2018-128747 is disclosed as related art.

### SUMMARY

According to an aspect of the embodiments, a non-transitory computer-readable recording medium stores a conversation control program for causing a computer to execute processing including: receiving a start instruction of a conversation with a chatbot from an information processing terminal used by a user, and receiving type information of the information processing terminal and information that specifies an operation time zone in the information processing terminal; in a case where the type information corresponds to a specific information processing terminal, referring to a storage unit that stores script information that corresponds to each of a plurality of operation time zones and defines processing regarding the conversation of the chatbot, and starting the conversation with the chatbot in the information processing terminal by using the script information determined on the basis of the received information that specifies an operation time zone; and in a case where the type information does not correspond to the specific information processing terminal, displaying information by which at least one of pieces of the script information that respectively corresponds to the plurality of operation time zones is selectable on the information processing terminal, and starting the conversation with the chatbot in the information processing terminal by using the selected script information, in response to the start instruction of the conversation with the chatbot.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a conversation control method according to an embodiment;

FIG. 2 is an explanatory diagram illustrating a system configuration example of a conversation control system 200;

FIG. 3 is a block diagram illustrating a hardware configuration example of an information processing device 101;

FIG. 4 is a block diagram illustrating a hardware configuration example of an information processing terminal 201;

FIG. 5 is an explanatory diagram illustrating an example of stored content of a script table 240;

FIG. 6 is an explanatory diagram illustrating a specific example of script information;

FIG. 7 is a block diagram illustrating an exemplary functional configuration of the information processing device 101;

FIG. 8 is an explanatory diagram (part 1) illustrating a screen example of a conversation screen;

FIG. 9 is an explanatory diagram (part 2) illustrating a screen example of the conversation screen;

FIG. 10 is an explanatory diagram (part 3) illustrating a screen example of the conversation screen;

FIG. 11 is an explanatory diagram (part 4) illustrating a screen example of the conversation screen;

FIG. 12 is an explanatory diagram (part 5) illustrating a screen example of the conversation screen;

FIG. 13 is an explanatory diagram (part 6) illustrating a screen example of the conversation screen;

FIG. 14 is an explanatory diagram (part 7) illustrating a screen example of the conversation screen;

FIG. 15 is an explanatory diagram (part 8) illustrating a screen example of the conversation screen;

FIG. 16 is an explanatory diagram illustrating an example of stored content of a script transfer table 1600;

FIG. 17 is a flowchart (part 1) illustrating an example of a conversation control processing procedure of the information processing device 101;

FIG. 18 is a flowchart (part 2) illustrating an example of the conversation control processing procedure of the information processing device 101; and

FIG. 19 is a flowchart illustrating an example of a conversation transfer processing procedure of the information processing device 101.

### DESCRIPTION OF EMBODIMENTS

As an existing technique, for example, there is a technique of updating a state management data for managing a state of a user on the basis of a user state data indicating the state of the user, which is specified by analyzing user's activity history data acquired by a user's mobile terminal, and determining an action for the user by referring to the state management data.

However, the existing technique has a problem that it takes a lot of steps for the user who uses a digital board or the like capable of two-way communication linked with a chatbot to obtain a desired answer, which incurs a withdrawal from a chat.

In one aspect, an object of the embodiment is to smoothly provide a service using a chatbot while suppressing a withdrawal from a chat.

Hereinafter, embodiments of a conversation control program, a conversation control method, and an information processing device will be described in detail with reference to the drawings.

### Embodiment

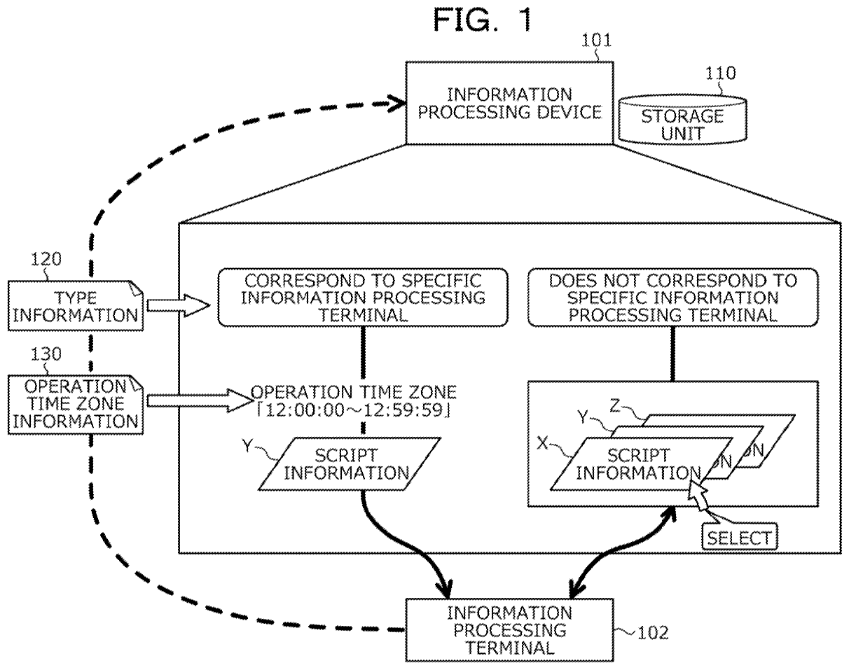

FIG. 1 is an explanatory diagram illustrating an example of a conversation control method according to an embodiment. In FIG. 1, an information processing device 101 is a computer that controls a conversation of a chatbot. The chatbot is a computer system that interacts with and exchanges messages with humans using artificial intelligence.

An information processing terminal 102 is a computer that a user uses to have a conversation with the chatbot. The information processing terminal 102 is, for example, a stationary information processing terminal installed in a highly public place such as a station or an airport or a place where goods and services are provided such as a store or a commercial facility. Furthermore, the information processing terminal 102 may be a portable information processing terminal that the individual user owns or that is rented to the user at a store or the like.

In the information processing terminal 102, the user can search for a desired answer or use the service while interacting with the chatbot by, for example, inputting a message or selecting an option. The answer is, for example, a frequently asked question (FAQ).

The FAQ means “frequently asked questions”, and is a collection of question data and answer data for questions expected in advance. The question may ask for a solution method to some problem, or it may be a spoken question. The answers include an answer indicating a solution method to the asked question and an answer to the spoken question.

Here, to automatically respond by chatbot to various requests from the user, options tend to be complicated and a hierarchy tends to be deep. The hierarchy being deep means increasing the number of times the user is forced to select an option. For example, to automatically respond by chatbot with about 1000 patterns of answers, the hierarchy has three layers of hierarchical structure.

However, when the hierarchy becomes deep or the number of options to be displayed at one time increases, it takes a lot of steps for the user to obtain a desired answer or use a desired service, which incurs a withdrawal from a chat (halfway withdrawal). With more withdrawals from a chat, for example, opportunities to introduce stores and services are lost and business opportunities may be lost. On the other hand, if the hierarchy is lowered or the number of options displayed at one time is reduced, the number of answers that the chatbot can automatically respond decreases, and it becomes difficult to respond to the user's request.

Here, FAQs and services that are frequently selected tend to change depending on a difference in a time zone. For example, there may be a tendency for certain FAQs or services to be more frequently selected in the afternoon than in the morning of a day. Such a tendency may appear not only in a day but also in units such as days of a week, weeks, months, and years, for example.

Furthermore, there are some cases where an available time differs even for services provided at the same store. In this case, it is conceivable that it is friendly to the user to present with priority messages or options related to services having a short available time among a plurality of services in consideration of last-minute use at the limit of the available time or the like. Furthermore, it can be said that it is less necessary to present with priority messages and options related to services that are not available because it is not the available time.

For example, there are some cases where messages and options to be presented with priority differ depending on an operation time zone of the information processing terminal 102. Therefore, it is conceivable to obtain a desired answer by a short move and prevent withdrawal from a chat by dynamically changing a script that defines a conversation flow of the chatbot in the information processing terminal 102 according to the operation time zone in the information processing terminal 102.

Meanwhile, it may be difficult for the user to operate the information processing terminal 102 alone depending on the user or content of a service. For example, in a case where the user is unfamiliar with the operation or uses a service that requires troublesome procedures, it is favorable to have the user perform the operation while being supported by a staff of the store or the like.

When the user operates with the support of the staff, even if there are many options, it is possible to lead to the desired answer with as few steps as possible while giving accurate advice. However, in such a use scene, it is assumed that the staff will carefully explain operation content to the user and the procedures will take time.

For this reason, in the case where the user performs the operation while being supported by the staff or the like, it is more favorable to perform the operation using a terminal of the individual user or a terminal carried by the staff than to perform the operation using a terminal (for example, a digital board equipped with a large display) installed assuming the use by an unspecified number of people.

Therefore, in the present embodiment, a conversation control method for smoothly providing a service using a chatbot while suppressing a withdrawal from a chat by controlling a conversation of the chatbot in consideration of which time zone an operation has been performed by which type of information processing terminal will be described. Hereinafter, a processing example of the information processing device 101 will be described.

(1) The information processing device 101 receives a start instruction of a conversation with a chatbot from the information processing terminal 102 that the user uses, and receives type information of the information processing terminal 102 and information that specifies an operation time zone in the information processing terminal 102. Here, the start instruction of a conversation with a chatbot is for starting a conversation between the user and the chatbot.

The type information of the information processing terminal 102 is information for determining whether the information processing terminal is a specific information processing terminal. The specific information processing terminal is, for example, an information processing terminal installed in a highly public place such as a station or an airport, a store, a commercial facility, or the like. The specific information processing terminal may be a stationary information processing terminal or a portable information processing terminal.

A specific example of the specific information processing terminal includes a digital board equipped with a large touch panel display used by an unspecified number of people. Furthermore, specific examples of the information processing terminal different from the specific information processing terminal include a smartphone that the individual user owns, a tablet personal computer (PC) lent to the user at, for example, a store, and the like.

The information that specifies the operation time zone is information that specifies the time zone in which the operation has been performed on the information processing terminal 102, and indicates, for example, date and time when a user operation for starting the conversation with the chatbot has been performed on the information processing terminal 102. The operation time zone may be divided using time or may be divided by date, for example. Furthermore, the operation time zone may be divided using date and time (date and time).

The example of FIG. 1 assumes a case where type information 120 and operation time zone information 130 of the information processing terminal 102 are received together with the start instruction of the conversation with the chatbot from the information processing terminal 102. The operation time zone information 130 is information that specifies the operation time zone in the information processing terminal 102.

(2) The information processing device 101 determines whether the received type information of the information processing terminal 102 corresponds to the specific information processing terminal in response to the start instruction of the conversation with the chatbot. In the example of FIG. 1, the information processing device 101 determines whether the type information 120 of the information processing terminal 102 corresponds to the specific information processing terminal.

(3) In a case where the type information of the information processing terminal 102 corresponds to the specific information processing terminal, the information processing device 101 starts the conversation with the chatbot in the information processing terminal 102, using script information determined on the basis of the received information that specifies the operation time zone by reference to a storage unit 110.

Here, the storage unit 110 stores the script information corresponding to each of a plurality of operation time zones. The script information is information (scenario) that defines processing related to the conversation of the chatbot. Specifically, for example, the script information is information that defines chat talk processing.

As described above, FAQs and services that are frequently selected tend to change depending on the difference in the time zone. Therefore, the information processing device 101 prepares the script information corresponding to each operation time zone in advance in consideration of frequently selected FAQs and services for each of the plurality of operation time zones.

In the example of FIG. 1, it is assumed that script information X corresponding to the operation time zone “9:00:00 to 11:59:59”, script information Y corresponding to the operation time zone “12:00:00 to 12:59:59”, and script information Z corresponding to the operation time zone “13:00:00 to 16:59:59” are stored in the storage unit 110.

The information processing device 101 refers to the storage unit 110 and determines the script information to be applied to the conversation of the chatbot on the basis of the received operation time zone information 130. Here, the operation time zone information 130 is assumed to be information indicating the time “12:15:30” when the operation has been performed on the information processing terminal 102. In this case, the operation time zone specified from the operation time zone information 130, of above-described the three operation time zones, is “12:00:00 to 12:59:59”. Therefore, the script information Y corresponding to the operation time zone “12:00:00 to 12:59:59” is determined as the script information to be applied to the conversation of the chatbot. Then, the information processing device 101 starts the conversation with the chatbot in the information processing terminal 102, using the determined script information Y.

(4) In a case where the type information of the information processing terminal 102 does not correspond to the specific information processing terminal, the information processing device 101 displays information by which at least one of the pieces of script information respectively corresponding to the plurality of operation time zones is selectable on the information processing terminal 102. Then, the information processing device 101 starts the conversation with the chatbot in the information processing terminal 102, using the selected script information.

In the example of FIG. 1, the information processing device 101 refers to the storage unit 110 and displays, for example, information by which the script information X, Y, and Z are selectable on the information processing terminal 102. Here, it is assumed that the script information X has been selected by a user's operation input in the information processing terminal 102. In this case, the information processing device 101 starts the conversation with the chatbot in the information processing terminal 102, using the selected script information X.

As described above, according to the information processing device 101, in the case where the type information of the information processing terminal 102 corresponds to the specific information processing terminal, it is possible to dynamically change the content and flow of the conversation of the chatbot in the information processing terminal 102 according to the operation time zone in the information processing terminal 102. As a result, it becomes possible to narrow down the options to be displayed at once or reduce the hierarchy of scripts in consideration of changes in the frequently used FAQs and services depending on differences in the time zone, changes in services to be presented with priority in relation to available time, and the like. For this reason, when the user uses the information processing terminal 102 (for example, a digital board) installed in a highly public place or store, the user can get a desired answer by a short move and a withdraw from a chat may be suppressed. Furthermore, since a desired answer can be obtained by a short move, it is possible to reduce the amount of processing per person and improve use efficiency of the information processing terminal 102.

Furthermore, according to the information processing device 101, in the case where the type information of the information processing terminal 102 does not correspond to the specific information processing terminal, it is possible to allow the user to select a talk script to be applied to the conversation of the chatbot. Furthermore, even if the user is unfamiliar with the operation or uses a service that requires troublesome procedures, it is possible to lead the user to a desired answer or service with as few steps as possible by having the user perform the operation while being supported by the staff.

(System Configuration Example of Conversation Control System 200)

Next, a system configuration example of a conversation control system 200 including the information processing device 101 illustrated in FIG. 1 will be described. The conversation control system 200 is applied to, for example, a FAQ system using the chatbot.

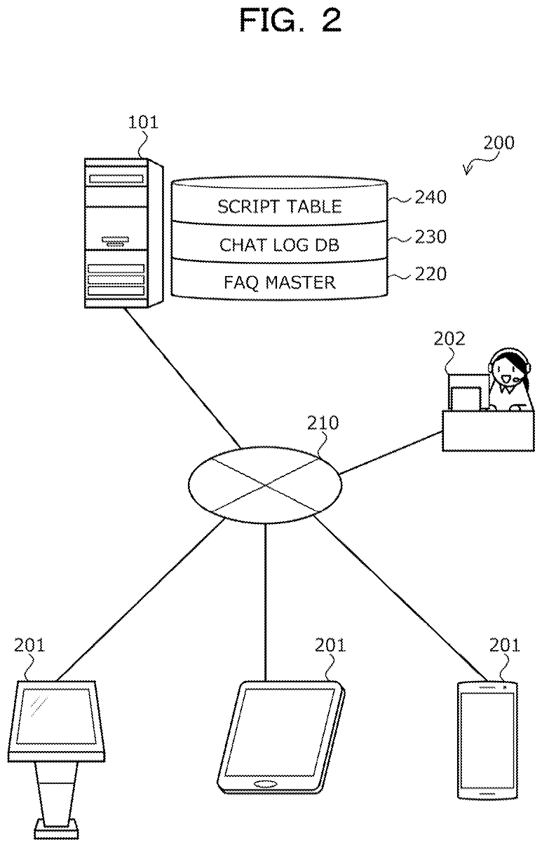

FIG. 2 is an explanatory diagram illustrating a system configuration example of the conversation control system 200. In FIG. 2, the conversation control system 200 includes the information processing device 101, a plurality of (three in the example of FIG. 2) information processing terminals 201, and an operator terminal 202. In the conversation control system 200, the information processing device 101, the plurality of information processing terminals 201, and the operator terminal 202 are connected via a wired or wireless network 210. The network 210 is, for example, a local area network (LAN), a wide area network (WAN), the Internet, or the like.

Here, the information processing device 101 includes an FAQ master 220, a chat log DB 230, and a script table 240, and controls the conversation of the chatbot in the information processing terminal 201. For example, the information processing device 101 is a server. The FAQ master 220 stores FAQ.

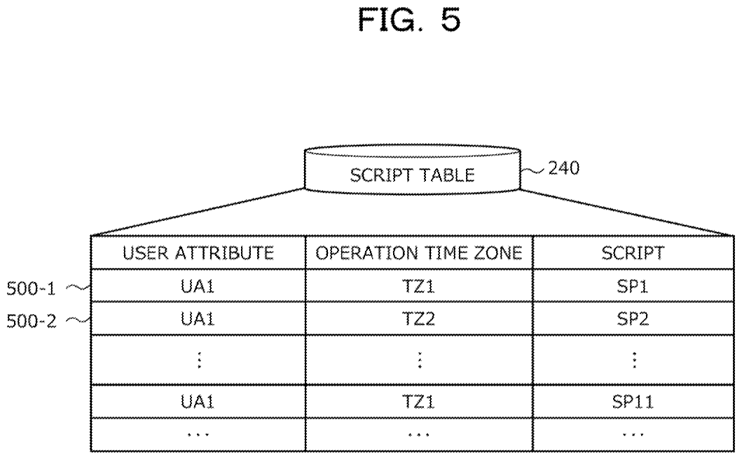

The chat log DB 230 stores a chat log. The chat log is a conversation history regarding the conversation between the user and the chatbot. The script table 240 stores script information that defines the conversation flow of the chatbot. The conversation with the chatbot is performed according to script information, for example. Note that stored content of the script table 240 will be described below with reference to FIG. 5.

The information processing terminal 201 is a computer that the user of the conversation control system 200 uses. The information processing terminal 201 is used when having a conversation with a chatbot, and performs interaction by the chatbot with the user according to the control of the information processing device 101.

For example, the information processing terminal 201 may be a digital board installed in a highly public place such as a station or an airport, a store, a commercial facility, or the like. Furthermore, the information processing terminal 201 may be a smartphone, a tablet PC, or the like that the individual user owns or is rented to the user. The information processing terminal 201 illustrated in FIG. 1 corresponds to, for example, the information processing terminal 201.

The operator terminal 202 is a computer that an operator uses. The operator is a person who responds to the user when the conversation is switched from the conversation by the chatbot to a manned conversation. For example, the operator can communicate with the user by using a telephone function of the operator terminal 202, text communication, or the like. For example, the operator terminal 202 is a PC or a tablet PC.

Note that, here, the information processing device 101 and the information processing terminal 201 are separately provided. However, the present embodiment is not limited thereto. For example, the information processing device 101 may be implemented by each information processing terminal 201.

(Hardware Configuration Example of Information Processing Device 101)

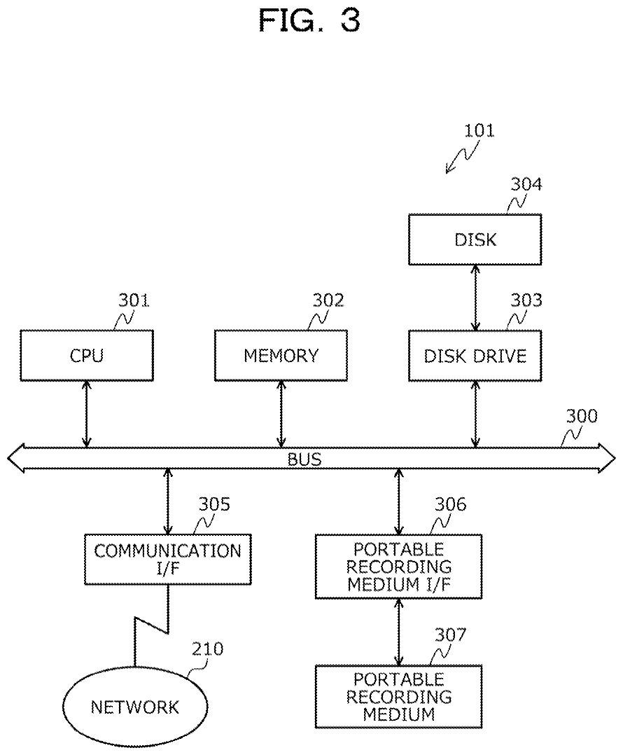

FIG. 3 is a block diagram illustrating a hardware configuration example of the information processing device 101. In FIG. 3, the information processing device 101 includes a central processing unit (CPU) 301, a memory 302, a disk drive 303, a disk 304, a communication interface (I/F) 305, a portable recording medium I/F 306, and a portable recording medium 307. Furthermore, the individual components are connected to each other by a bus 300.

Here, the CPU 301 performs overall control of the information processing device 101. The CPU 301 may include a plurality of cores. The memory 302 includes, for example, a read only memory (ROM), a random access memory (RAM), a flash ROM, and the like. Specifically, for example, the flash ROM stores an operating system (OS) program, the ROM stores an application program, and the RAM is used as a work area for the CPU 301. The program stored in the memory 302 is loaded to the CPU 301 to cause the CPU 301 to execute coded processing.

The disk drive 303 controls reading/writing of data from/to the disk 304 under the control of the CPU 301. The disk 304 stores data written under the control of the disk drive 303. Examples of the disk 304 include a magnetic disk, an optical disk, and the like.

The communication I/F 305 is connected to the network 210 through a communication line, and is connected to external computers (for example, the information processing terminal 201, the operator terminal 202 illustrated in FIG. 2, and the like) via the network 210. Then, the communication I/F 305 manages an interface between the network 210 and the inside of the device, and controls input and output of data from an external computer. For example, a modem, a LAN adapter, or the like may be employed as the communication I/F 305.

The portable recording medium I/F 306 controls read/write of data from/to the portable recording medium 307 under the control of the CPU 301. The portable recording medium 307 stores data written under the control of the portable recording medium I/F 306. Examples of the portable recording medium 307 include a compact disc (CD)-ROM, a digital versatile disk (DVD), a universal serial bus (USB) memory, and the like.

Note that the information processing device 101 may include, for example, a solid state drive (SSD), an input device, a display, and the like in addition to the components described above. Furthermore, the information processing device 101 may not include, for example, the disk drive 303, the disk 304, the portable recording medium I/F 306, and the portable recording medium 307 among the components described above.

(Hardware Configuration Example of Information Processing Terminal 201)

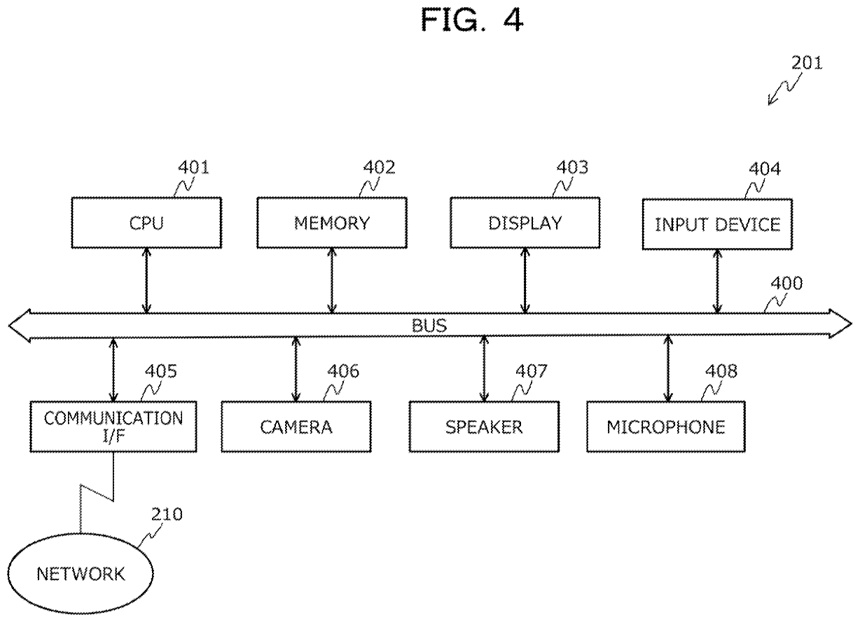

FIG. 4 is a block diagram illustrating a hardware configuration example of the information processing terminal 201. In FIG. 4, the information processing terminal 201 has a CPU 401, a memory 402, a display 403, an input device 404, a communication I/F 405, a camera 406, a speaker 407, and a microphone 408. Furthermore, the individual components are connected to each other via a bus 400.

Here, the CPU 401 performs overall control of the information processing terminal 201. The CPU 401 may include a plurality of cores. The memory 402 is a storage unit including, for example, a ROM, a RAM, a flash ROM, and the like. For example, the flash ROM or the ROM stores various programs, while the RAM is used as a work area for the CPU 401. A program stored in the memory 402 is loaded to the CPU 401 to cause the CPU 401 to execute coded processing.

The display 403 is a display device that displays data such as a document, an image, or function information, as well as a cursor, icons, or tool boxes. For example, a liquid crystal display, an organic electroluminescence (EL) display, or the like may be adopted as the display 403.

The input device 404 has keys for inputting characters, numbers, various commands, and the like, and inputs data. The input device 404 may be a touch-panel input pad, a numeric keypad, or the like or may be a keyboard, a mouse, or the like.

The communication I/F 405 is connected to the network 210 through a communication line, and is connected to an external computer (for example, the information processing device 101 or the operator terminal 202) via the network 210. Then, the communication I/F 405 manages an interface between the network 210 and the inside of the local device, and controls input/output of data from an external device.

The camera 406 is a capture device that captures an image (still image or moving image) and outputs image data. The speaker 407 converts an electrical signal into a sound and outputs the sound. The microphone 408 receives a sound and converts the sound into an electrical signal.

Note that the information processing terminal 201 may include, for example, a hard disk drive (HDD), an SSD, a short-range wireless communication I/F, a portable recording medium I/F, a portable recording medium, a global positioning system (GPS) unit, and the like, in addition to the above-described components. Furthermore, the operator terminal 202 illustrated in FIG. 2 can also be implemented by a hardware configuration similar to the information processing terminal 201.

(Stored Content of Script Table 240)

Next, stored content of the script table 240 included in the information processing device 101 will be described with reference to FIG. 5. The script table 240 is implemented by, for example, a storage device such as the memory 302 or the disk 304 illustrated in FIG. 3.

FIG. 5 is an explanatory diagram illustrating an example of the stored content of the script table 240. In FIG. 5, the script table 240 has fields for user attribute, operation time zone, and script, and stores script management information (for example, script management information 500-1 and 500-2) as a record by setting information in the respective field.

Here, the user attribute represents a characteristic of the user. Note that, here, an attribute ID (for example, UA1, UA2, . . . ) that identifies the user attribute is described. For example, the user attribute is classified by at least one or a combination of generation, gender, language, clothing, position information, meteorological information, or the like. Examples of the user attribute include “female”, “20s×female”, “30s×male”, “20s×female×with children”, “20s×female×language (English)”, “20s×female×couple”, “20s×female×weather (rain)”, “20s×female×temperature (25° C. or higher)”, “20s×male×place (Akihabara)”, “20s×clothing (glasses)”, and the like. Note that, as the user attribute, for example, an attribute intended for all of users such as “ALL” may be provided.

The operation time zone represents a time zone in which the user's operation is performed. Note that, here, a time zone ID (for example, TZ1, TZ2, . . . ) that identifies the operation time zone is described. For example, the operation time zone may be divided using time or may be divided by date. Furthermore, the operation time zone may be divided using date and time (date and time). Examples of the operation time zone include “12:00:00 to 13:59:59”, “July 22 to August 16”, “09:00:00 to 16:59:59 on 25th”, and the like.

The script is script information (scenario) that defines the flow of the conversation of the chatbot, and is prepared in association with the user attribute and the operation time zone. Note that, here, a script ID (for example, SP1, SP2, . . . ) that identifies the script is described.

For example, the script management information 500-1 indicates the script information SP1 corresponding to a combination of the user attribute UA1 and the operation time zone TZ1.

Note that what script information is associated with which user attribute and which operation time zone is determined by analyzing the chat log stored in the chat log DB 230 illustrated in FIG. 2, for example. For example, the script information is created in consideration of changes in the frequently used FAQs, services depending on the difference in the time zone, and the like. Furthermore, the script information is created in consideration of, for example, changes in services to be presented with priority or services less necessary to be presented with priority in relation to the available time.

Furthermore, the script management information stored in the script table 240 is prepared for each service available in the information processing terminal 201, for example. As services, for example, there are various services provided by banks, various services provided at stations, airports, and the like. More specifically, for example, the script table 240 may be provided for each facility or store that provides a service.

(Specific Example of Script Information)

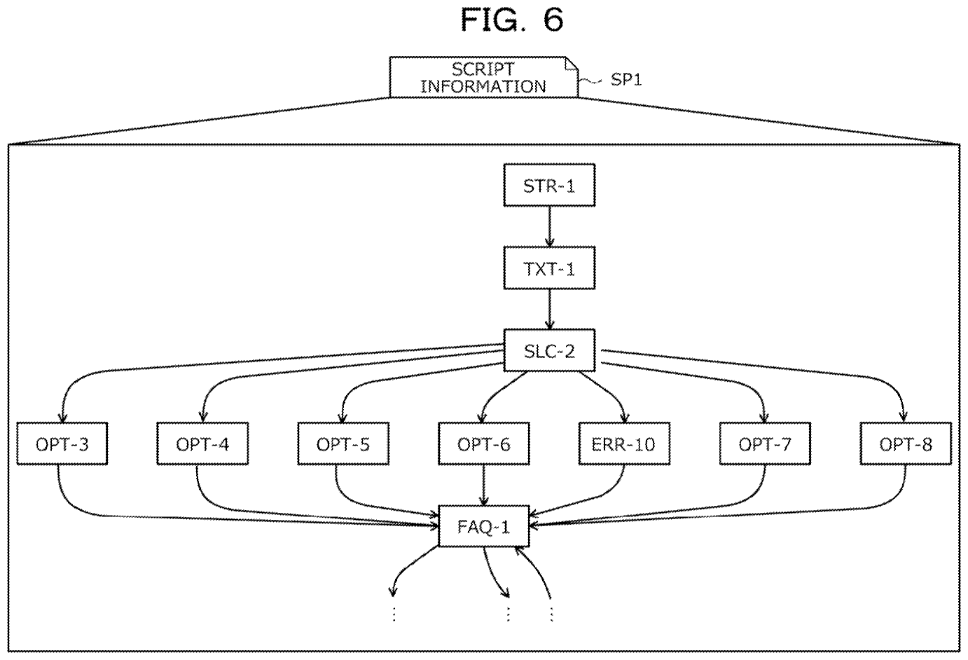

Here, a specific example of the script information will be described with reference to FIG. 6. Here, the script information SP1 corresponding to the combination of the user attribute UA1 and the operation time zone TZ1 will be described as an example.

FIG. 6 is an explanatory diagram illustrating a specific example of the script information. In FIG. 6, the script information SP1 is information (scenario) that defines the flow of the conversation flow of the chatbot. Note that FIG. 6 excerpts and displays a part of the script information SP1. Specifically, for example, the script information SP1 is information that defines chat talk processing.

The talk processing is processing for implementing an operation (behavior) of the chatbot. For example, the talk processing includes processing of speaking, processing of displaying options, processing of selecting an option according to a user operation, processing of performing a procedure according to the selected option or input information, processing of terminating the talk processing, and the like.

In the script information SP1, for example, STR-1 indicates the start of the talk processing. TXT-1 indicates the processing of speaking a message. SLC-2 indicates the processing of displaying options of OPT-3 to OPT-8. FAQ-1 indicates processing of searching for and displaying an FAQ according to the option. Note that ERR-10 indicates error processing. The search for an FAQ is performed using, for example, the FAQ master 220 illustrated in FIG. 2.

(Functional Configuration Example of Information Processing Device 101)

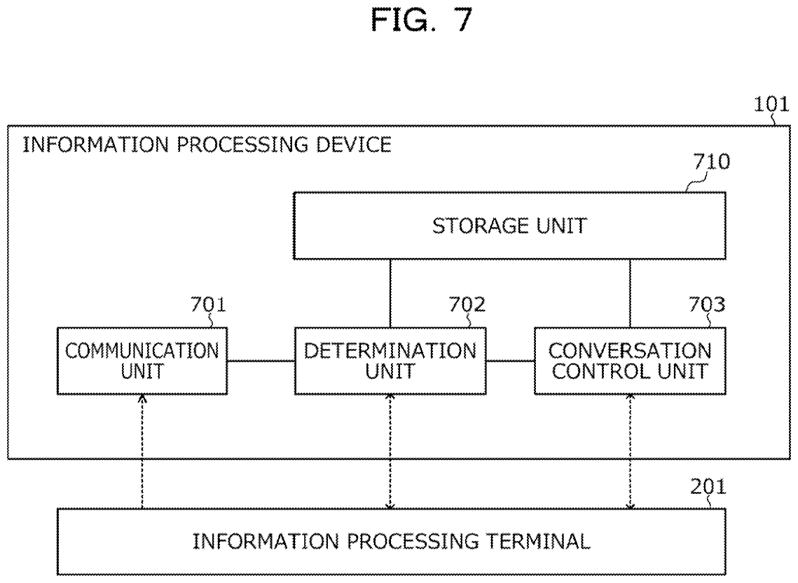

FIG. 7 is a block diagram illustrating a functional configuration example of the information processing device 101. In FIG. 7, the information processing device 101 includes a communication unit 701, a determination unit 702, a conversation control unit 703, and a storage unit 710. Specifically, for example, the communication unit 701 to the conversation control unit 703 implement its functions by causing the CPU 301 to execute a program stored in the storage device such as the memory 302, the disk 304, or the portable recording medium 307 illustrated in FIG. 3, or by the communication I/F 305. A processing result of each functional unit is stored in, for example, the storage device such as the memory 302 or the disk 304. The storage unit 710 is implemented by a storage device such as the memory 302 or the disk 304, for example. Specifically, for example, the storage unit 710 stores the script table 240 illustrated in FIG. 5.

The communication unit 701 receives the start instruction of the conversation with the chatbot from the information processing terminal 201 that the user uses, and receives the information that specifies the operation time zone in the information processing terminal 201. Here, the start instruction of a conversation with a chatbot is for starting a conversation between the user and the chatbot.

The information that specifies the operation time zone is information that specifies a time zone in which the user's operation has been performed. The operation time zone is divided using at least either the date or the time, for example. Furthermore, the operation time zone may be divided using a day, a weekday, a holiday, or the like. In the following description, there are some cases where the information that specifies the operation time zone in the information processing terminal 201 is described as “operation time zone information of the information processing terminal 201”.

Furthermore, the communication unit 701 receives the start instruction of the conversation with the chatbot from the information processing terminal 201 that the user uses, and may further receive the type information of the information processing terminal 201. The type information of the information processing terminal 201 is information for determining whether the information processing terminal is a specific information processing terminal.

The type information of the information processing terminal 201 is set in advance and stored in the information processing terminal 201, for example. As an example, in a case where the type information of the information processing terminal 201 is “1”, the case indicates that the information processing terminal 201 is the specific information processing terminal. In a case where the type information of the information processing terminal 201 is “0”, the case indicates that the information processing terminal 201 is not the specific information processing terminal.

The specific information processing terminal is, for example, an information processing terminal such as a digital board equipped with a large touch panel display installed in a highly public place such as a station or an airport, a store, a commercial facility, or the like. However, even the information processing terminal that the individual user owns or the information processing terminal lent to the user may be able to be treated as the specific information processing terminal by setting the information processing terminal.

Furthermore, the communication unit 701 receives the start instruction of the conversation with the chatbot from the information processing terminal 201 that the user uses, and may further receive the attribute information of the user acquired by the information processing terminal 201. The attribute information of the user is information representing characteristics of the user.

For example, the attribute information of the user is information that specifies the generation, gender, language, clothing, presence or absence of a wheelchair, presence or absence of a companion of the user, and the like. Furthermore, the attribute information of the user may be position information (latitude, longitude, altitude, and the like) indicating a user's current position, and meteorological information (temperature, humidity, weather, and the like) of a user's current position.

Specifically, for example, in the case of detecting the user captured by the camera 406 (see FIG. 4), the information processing terminal 201 extracts the attribute information of the user in response to the user's operation input using the input device 404 (see FIG. 4). Then, the information processing terminal 201 transmits the extracted attribute information of the user to the information processing device 101 together with, for example, the start instruction of the conversation with the chatbot.

More specifically, for example, the information processing terminal 201 may analyze image data (for example, a moving image) captured by the camera 406 and extract the attribute information such as the generation, gender, clothing, presence or absence of a wheelchair, or presence or absence of a companion of the user. Furthermore, the information processing terminal 201 may analyze sound data received by the microphone 408 (see FIG. 4) and acquire the attribute information of the user such as the gender or language of the user.

Furthermore, the information processing terminal 201 may acquire the meteorological information such as temperature, humidity, or weather by using an environment sensor (not illustrated) or by inquiring an external server. Furthermore, the information processing terminal 201 may acquire the position information indicating the current position by a GPS unit (not illustrated). Note that, in a case where the information processing terminal 201 is a computer on an installation side of the digital board or the like, the position information indicating an installation position of the information processing terminal 201 may be stored in advance.

Thereby, in the information processing terminal 201, the attribute information such as the user's generation, gender, language, clothing, presence or absence of a wheelchair, presence or absence of a companion, position, and weather can be acquired.

Note that any existing technique may be used as the technique of extracting the attribute information of the user from the image data and the sound data. For example, the information processing terminal 201 may extract the attribute information such as the generation, gender, clothing, language, presence or absence of a wheelchair, or presence or absence of a companion from a characteristic amount of an image or a sound by a method based on machine learning such as deep learning.

Note that the information processing terminal 201 may have, for example, the attribute information of the user input by the user's operation input using the input device 404 (see FIG. 4). In this case, the information processing terminal 201 transmits the input attribute information of the user to the information processing device 101 together with, for example, the start instruction of the conversation with the chatbot.

Furthermore, the communication unit 701 may receive the image data captured by the camera 406 or the sound data received by the microphone 408 as the attribute information of the user. In this case, in the information processing device 101, the attribute information such as the generation, gender, clothing, and language may be extracted from the received image data and sound data. For example, the processing of analyzing the image data or the sound data may not be performed on the information processing terminal 201 side.

The determination unit 702 determines the script information to be applied to the conversation of the chatbot in response to the start instruction of the conversation with the chatbot. Specifically, for example, the determination unit 702 determines whether the received type information of the information processing terminal 201 corresponds to the specific information processing terminal in response to the start instruction of the conversation with the chatbot.

For example, in the case where the type information of the information processing terminal 201 is “1”, the determination unit 702 determines that the information processing terminal 201 corresponds to the specific information processing terminal. On the other hand, in the case where the type information of the information processing terminal 201 is “0”, the determination unit 702 determines that the information processing terminal 201 does not correspond to the specific information processing terminal.

First, the case where the type information of the information processing terminal 201 corresponds to the specific information processing terminal will be described.

In the case where the type information of the information processing terminal 201 corresponds to the specific information processing terminal, the determination unit 702 refers to the storage unit 710 and determines the script information to be applied to the conversation of the chatbot on the basis of the received operation time zone information. The storage unit 710 stores the script information corresponding to each of a plurality of operation time zones.

The script information is information (scenario) that defines processing related to the conversation of the chatbot. In the script information, for example, processing of switching the conversation by the chatbot to the manned conversation when a specific condition is satisfied on the basis of the conversation history in the chatbot may be described. Furthermore, in the script information, processing of changing the options to be displayed on the information processing terminal 201 on the basis of the conversation history of the chatbot may be described.

Here, the operation time zone information of the information processing terminal 201 is assumed to be information indicating the date and time “10:00:00 on Aug. 4 2019” when the user operation for starting the conversation with the chatbot has been performed in the information processing terminal 201. In the following description, there are some cases where the script information to be applied to the conversation of the chatbot in the information processing terminal 201 is described as “talk script”.

In this case, the determination unit 702 refers to the storage unit 710 and may determine the script information corresponding to the operation time zone including the time “10:00:00” among the plurality of operation time zones as the talk script. Furthermore, the determination unit 702 refers to the storage unit 710 and may determine the script information corresponding to the operation time zone including the date “August 04” among the plurality of operation time zones as the talk script. Year-month-day may be used as the date. Furthermore, the determination unit 702 refers to the storage unit 710 and may determine the script information corresponding to the operation time zone including the date and time “10:00:00 on August 04” among the plurality of operation time zones as the talk script.

Note that a priority may be set in advance to the script information corresponding to each of the plurality of operation time zones. For example, there are some cases where a plurality of pieces of script information specified from the operation time zone information of the information processing terminal 201 is present. In this case, the determination unit 702 may determine the script information having the highest priority among the plurality of pieces of script information specified from the operation time zone information as the talk script.

Furthermore, the storage unit 710 may store the script information corresponding to each of a plurality of combinations of the user attribute and the operation time zone (for example, the script table 240 illustrated in FIG. 5). Then, in the case where the type information of the information processing terminal 201 corresponds to the specific information processing terminal, the determination unit 702 may refer to the storage unit 710 and determine the talk script on the basis of the received attribute information of the user and operation time zone information.

Here, the operation time zone information of the information processing terminal 201 is assumed to be information indicating the date and time “10:00:00 on Aug. 4 2019” when the operation has been performed in the information processing terminal 201. In this case, the determination unit 702 refers to, for example, the script table 240, and specifies the operation time zone corresponding to the date and time “10:00:00 on Aug. 4 2019” among the plurality of operation time zones. Here, it is assumed that the operation time zone “July 22 to August 16” including the date “August 04” is specified. Furthermore, the attribute information of the user is assumed to be “generation “under 10 years old””. In this case, the determination unit 702 specifies the user attribute “under 10 years old” on the basis of the attribute information of the user. Then, the determination unit 702 refers to, for example, the script table 240, and determines the script information corresponding to the combination of the specified user attribute “under 10 years old” and the operation time zone “July 22 to August 16” as the talk script.

Furthermore, the operation time zone information of the information processing terminal 201 is assumed to be information indicating the date and time “07:00:00 on Dec. 31 2019” when the operation has been performed in the information processing terminal 201. In this case, the determination unit 702 refers to, for example, the script table 240 and specifies the operation time zone corresponding to the date and time “07:00:00 on Dec. 31 2019” among the plurality of operation time zones. Here, it is assumed that the operation time zone “Dec. 31 2019 to Jan. 7 2020” including the date “Dec. 31 2019” is specified. Furthermore, the attribute information of the user is assumed to be “generation “70s”, gender “female””. In this case, the determination unit 702 specifies the user attribute “70s×female” on the basis of the attribute information of the user. Then, the determination unit 702 refers to the script table 240, and determines the script information corresponding to the combination of the specified user attribute “70s×female” and the operation time zone “Dec. 31 2019 to Jan. 7 2020” as the talk script.

Note that there are some cases where the script information corresponding to the specified user attribute does not exist in the script table 240. In this case, the determination unit 702 may refer to the script table 240 and determine the script information corresponding to the combination of the user attribute “ALL” and the operation time zone as the talk script. Furthermore, the determination unit 702 may refer to the script table 240 and determine the script information corresponding to a combination of at least one element of the user attributes and the operation time zone as the talk script.

For example, it is assumed that there is no script information corresponding to the user attribute “20s×female×rain”. In this case, the determination unit 702 may refer to the script table 240 and determine the script information corresponding to the combination of the user attribute of one of “20s×female”, “20s×rain”, and “female×rain” and the operation time zone as the talk script.

Next, the case where the type information of the information processing terminal 201 does not correspond to the specific information processing terminal will be described.

In the case where the type information of the information processing terminal 201 does not correspond to the specific information processing terminal, the determination unit 702 displays the information by which at least one of the pieces of script information respectively corresponding to the plurality of operation time zones is selectable on the information processing terminal 201. Then, the determination unit 702 determines the selected script information as the talk script. The information by which the script information is selectable is, for example, information by which the service corresponding to each script information is specifiable.

Specific examples of the information by which the script information is selectable include an icon representing the content of the service corresponding to the script information, a button displayed with a message indicating the content of the service, and the like. It is possible to arbitrarily set which script information corresponding to which operation time zone is displayed in a selectable manner.

Specifically, for example, the determination unit 702 may refer to the storage unit 710 and display, on the information processing terminal 201, an operation screen on which the icons representing pieces of content of services corresponding to pieces of the script information respectively corresponding to the plurality of operation time zones are arranged in a selectable manner. Then, the determination unit 702 determines the script information corresponding to the selected icon as the talk script.

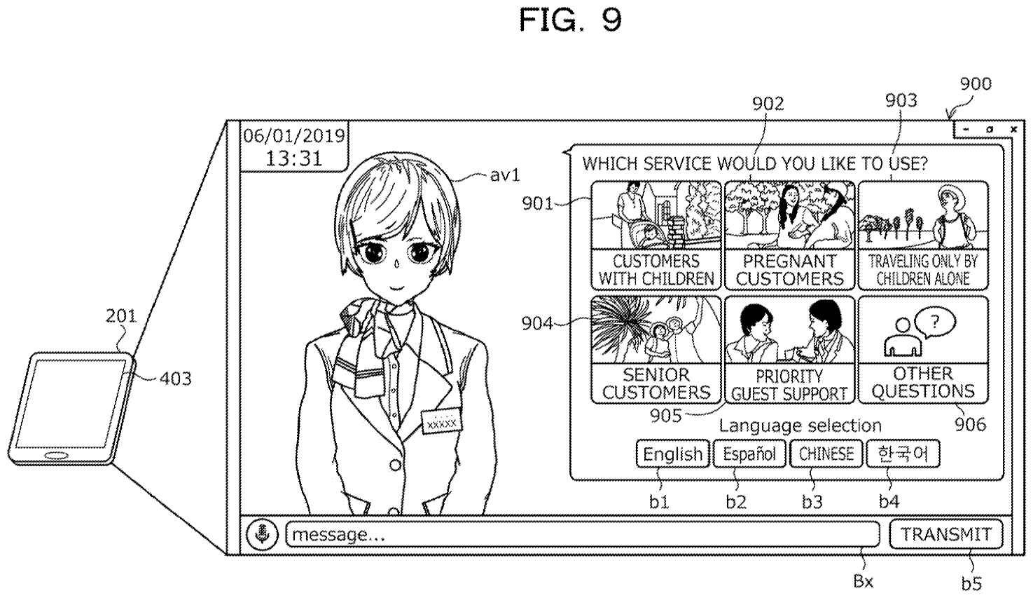

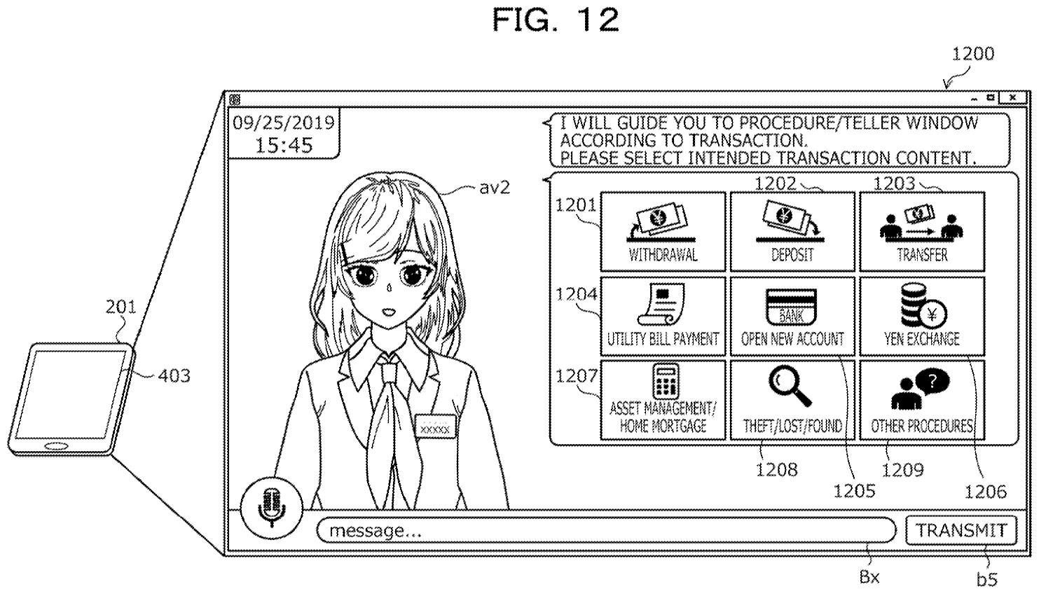

Note that a screen example of the operation screen displaying information by which the script information is selectable will be described below with reference to, for example, FIGS. 9 and 12.

The conversation control unit 703 starts the conversation with the chatbot in the information processing terminal 201 by using the determined talk script. Specifically, for example, the conversation control unit 703 uses the chatbot to speak, display options, and searches for and displays an FAQ according to the selected option according to the talk script.

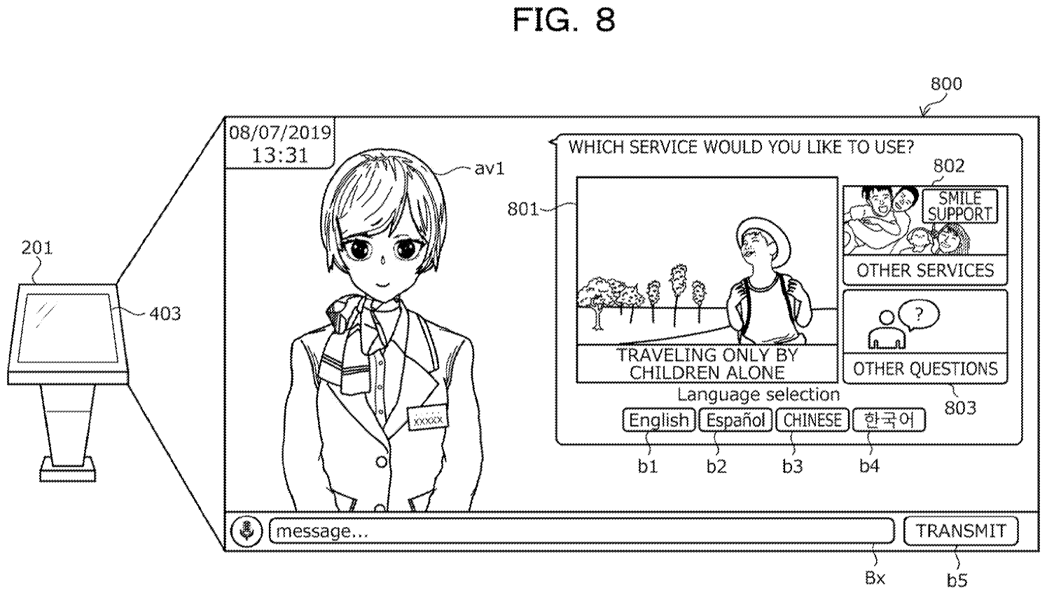

Note that the conversation history between the chatbot and the user in the information processing terminal 201 (so-called chat log) is stored in, for example, the chat log DB 230 illustrated in FIG. 2. Furthermore, a screen example of a conversation screen displayed on the display 403 of the information processing terminal 201 will be described below with reference to, for example, FIGS. 8 to 12.

Here, in the talk script, there are some cases where processing of switching the conversation by the chatbot to the manned conversation when a specific condition is satisfied on the basis of the conversation history with the chatbot is described. In this case, for example, the conversation control unit 703 determines whether a specific condition is satisfied on the basis of the conversation history after starting the conversation of the chatbot according to the talk script.

For example, the conversation control unit 703 may determine that the specific condition is satisfied when specific keywords are input on the basis of the conversation history. The specific keywords can be set arbitrarily. For example, the specific keywords may be complaint keywords such as “Let me talk to someone in charge” or “Let me talk to the manager”, or may be business keywords such as “luxury French” or “resort”.

Furthermore, the conversation control unit 703 may determine that the specific condition is satisfied in a case where, for example, when a specific option has been selected a plurality of times on the basis of the conversation history. The specific option is, for example, “no suitable option in here”, “No”, or the like, which is selected in a case where desired information is not able to be obtained.

In the case of determining that the specific condition is satisfied, the conversation control unit 703 may display an operation button capable of switching the conversation by the chatbot to the manned conversation on the information processing terminal 201. Then, the conversation control unit 703 may connect the information processing terminal 201 and the operator terminal 202 to switch the conversation by the chatbot to the manned conversation in response to the selection of the operation button.

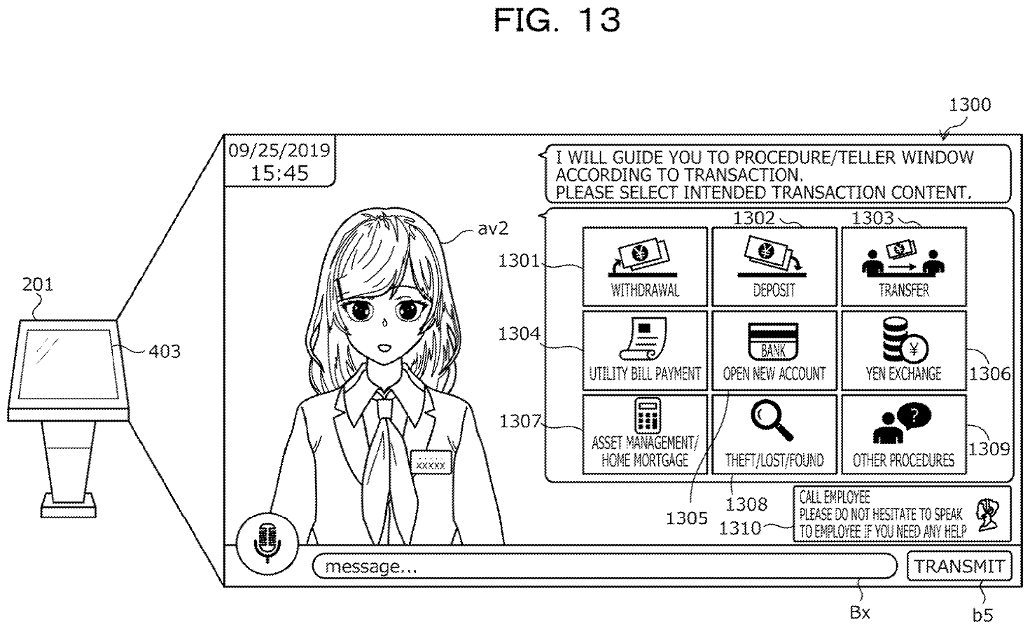

Note that a display example of the operation button capable of switching the conversation by the chatbot to the manned conversation will be described below with reference to FIG. 13.

Furthermore, in the talk script, there are some cases where processing of changing the options to be displayed on the information processing terminal 201 on the basis of the conversation history of the chatbot is described. In this case, for example, the conversation control unit 703 changes the options to be displayed on the basis of the conversation history after starting the conversation of the chatbot according to the talk script.

Specifically, for example, in processing of displaying a specific option, the conversation control unit 703 causes the chatbot to display a predetermined question sentence before displaying the specific option, and changes the options to be displayed according to an answer to the predetermined question sentence. The specific option is, for example, an option that may be inappropriate depending on the age of the user.

Furthermore, the conversation control unit 703 may cause the information processing terminal 201 to output the transfer guidance of the conversation in a case where the conversation content received from the information processing terminal 201 satisfies a predetermined condition after the start of the conversation with the chatbot in the information processing terminal 201. Here, the conversation content includes, for example, the selected option and an input message in the conversation with the chatbot in the information processing terminal 201.

The transfer guidance interrupts the conversation in the open chat and encourages a subsequent conversation in a closed chat. For example, the transfer guidance interrupts the conversation on the digital board installed in a highly public place or the information processing terminal 201 rented out to the user at a store or the like, and encourages a subsequent conversation on another information processing terminal 201 that the individual user owns.

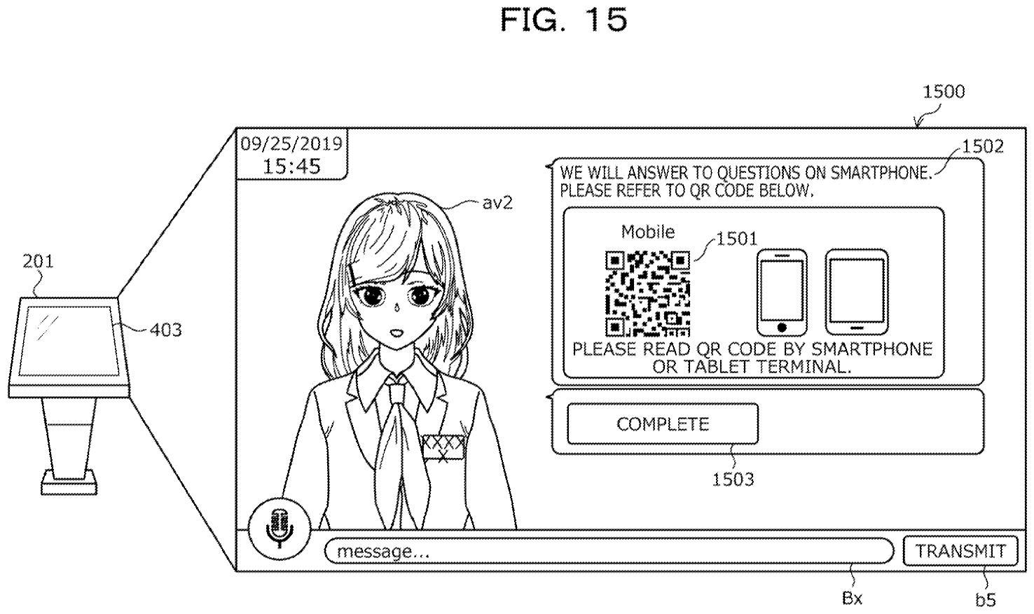

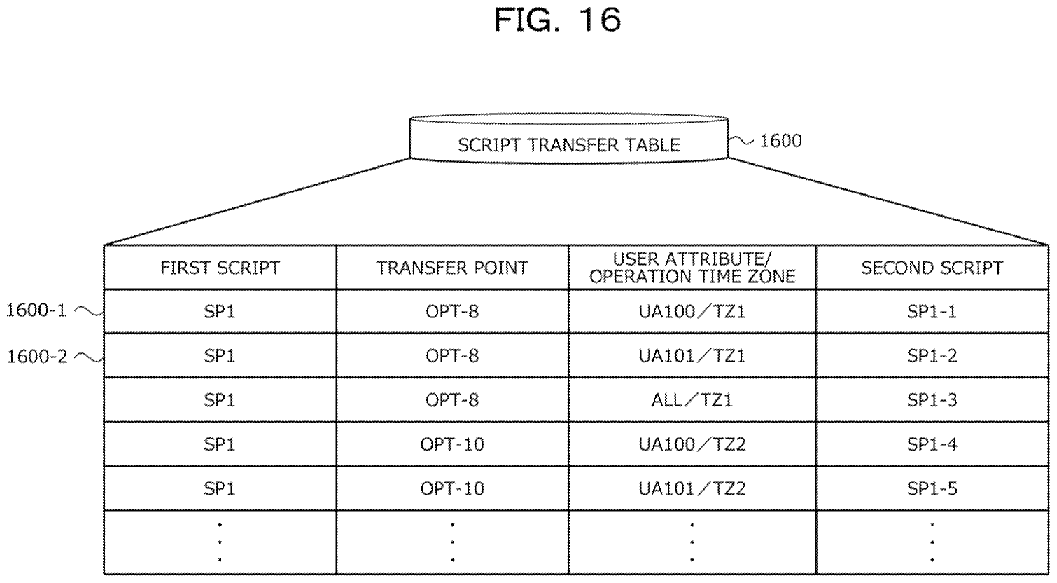

Note that an operation example where the conversation with the chatbot in the information processing terminal 201 is taken over by another information processing terminal 201 will be described below with reference to FIGS. 15 and 16.

The above-described each functional unit of the information processing device 101 may be implemented by a plurality of computers (for example, the information processing device 101 and the information processing terminal 201) in the conversation control system 200.

(Screen Examples of Conversation Screen)

Next, a screen example of a conversation screen displayed on the display 403 of the information processing terminal 201 will be described with reference to FIGS. 8 to 15. First, a screen example of the conversation screen displayed on the display 403 of the information processing terminal 201 will be described taking a service provided by an airline as an example with reference to FIGS. 8 and 9.

FIG. 8 is an explanatory diagram (part 1) illustrating a screen example of the conversation screen. The example of FIG. 8 assumes a case where the type information of the information processing terminal 201 corresponds to the specific information processing terminal. For example, a case where the information processing terminal 201 is an information processing terminal such as a digital board installed at an airport is assumed. Furthermore, the user attribute specified from the attribute information of the user acquired by the information processing terminal 201 is assumed to be “under 10 years old”, and the operation time zone specified from the operation time zone information of the information processing terminal 201 is assumed to be “July 22 to August 16”

In FIG. 8, a conversation screen 800 is an example of the conversation screen displayed on the display 403 of the information processing terminal 201 when the conversation with the chatbot is started using the talk script corresponding to the combination of the user attribute “under 10 years old” and the operation time zone “July 22 to August 16”. In FIG. 8, an avatar av1 is a character representing an airport employee.

The conversation screen 800 is an operation screen displayed when the user (a child under 10 years old) tries to use the information processing terminal 201 in a period when the number of kids traveling alone increases. According to the conversation screen 800, the user can have a conversation with the chatbot according to the talk script leading to FAQs and services related to kids traveling alone, which are often selected by users of the same generation around the same time period.

For example, by selecting a selection button 801 by the user's operation input using the input device 404 illustrated in FIG. 4 on the conversation screen 800, the conversation proceeds to the next conversation, and the service related to kids traveling alone, for example, a traveling support service or the like can be used.

Furthermore, when selecting a selection button 802 on the conversation screen 800, a conversation related to other services can be performed. Furthermore, when selecting a selection button 803 on the conversation screen 800, a conversation related to other questions can be performed. The selection buttons 802 and 803 are selected in a case where, for example, the service related to kids traveling alone is not the desired service.

Furthermore, when selecting a language button b1, b2, b3, or b4 on the conversation screen 800, the language to use can be switched. For example, when the user selects the language button b1, the language to use can be switched from Japanese to English.

Furthermore, a message can be input by selecting a box Bx, and the message input to the box Bx can be transmitted to the chatbot side (information processing device 101) by selecting a transmission button b5, on the conversation screen 800.

In this way, according to the conversation screen 800, it is possible to reduce the number of steps to reach the service related to kids traveling alone. Furthermore, since the options are narrowed down in advance, even if the user is a small child, the user can proceed with the conversation without hesitating the operation.

FIG. 9 is an explanatory diagram (part 2) illustrating a screen example of the conversation screen. The example of FIG. 9 assumes a case where the type information of the information processing terminal 201 does not correspond to the specific information processing terminal. For example, a case where the information processing terminal 201 is an information processing terminal that the individual user owns or is rented to the user is assumed.

In FIG. 9, a conversation screen 900 is an example of an operation screen on which the talk script to be applied to the conversation of the chatbot is selectable. In FIG. 9, an avatar av1 is a character representing an airport employee. On the conversation screen 900, selection buttons 901 to 905 for specifying services corresponding to pieces of script information respectively corresponding to the plurality of operation time zones are displayed.

On the conversation screen 900, the talk script can be selected by selecting one of the selection buttons 901 to 905 by the user's operation input using the input device 404.

For example, when selecting the selection button 901, the user can have a conversation with the chatbot according to the talk script leading to FAQs and services for customers with babies. This talk script corresponds to, for example, the script information corresponding to the user attribute “20s×female×with children” and the operation time zone “06:00:00 to 18:59:59”.

Furthermore, when selecting the selection button 902, the user can have a conversation with the chatbot according to the talk script leading to FAQs and services for pregnant customers. This talk script corresponds to, for example, the script information corresponding to the user attribute “20s or 30s×female” and the operation time zone “10:00:00 to 18:59:59”.

Furthermore, when selecting the selection button 903, the user can have a conversation with the chatbot according to the talk script leading to FAQs and services related to traveling by only children alone. This talk script corresponds to, for example, the script information corresponding to the user attribute “under 10 years old” and the operation time zone “July 22 to August 16”

Furthermore, when selecting the selection button 904, the user can have a conversation with the chatbot according to the talk script leading to FAQs and services for senior customers. This talk script corresponds to, for example, the script information corresponding to the user attribute “70s” and the operation time zone “July 01 to September 30”.

Furthermore, when selecting the selection button 905, the user can have a conversation with the chatbot according to the talk script leading to FAQs and services related to priority guest support. This talk script corresponds to, for example, the script information corresponding to the user attribute “wheelchair” and the operation time zone “ALL”.

Furthermore, when selecting the selection button 906 on the conversation screen 900, the content of the selection button can be updated and the selectable talk script can be changed.

Furthermore, when selecting the language button b1, b2, b3, or b4 on the conversation screen 900, the language to use can be switched. Furthermore, a message can be input by selecting the box Bx, and the message input to the box Bx can be transmitted to the chatbot side (information processing device 101) by selecting the transmission button b5, on the conversation screen 900.

In this way, according to the conversation screen 900, it is possible to allow the user to select the talk script to be applied to the conversation of the chatbot. Furthermore, even if the user is unfamiliar with the operation or uses a service that requires troublesome procedures, it is possible to lead the user to a desired answer or service with as few steps as possible by having the user perform the operation while being supported by the staff of the airport.

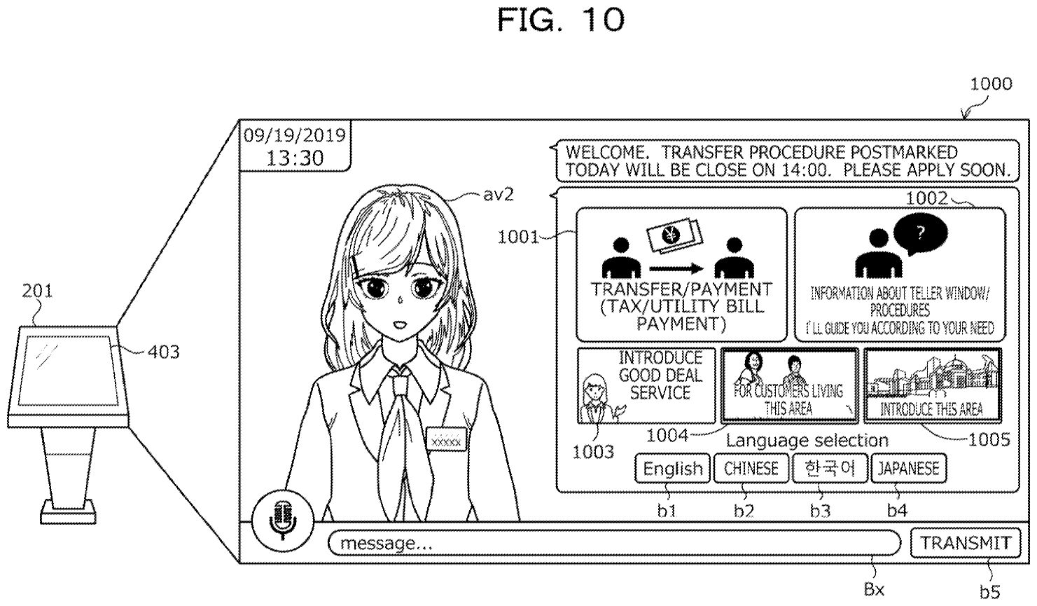

Next, a screen example of the conversation screen displayed on the display 403 of the information processing terminal 201 will be described taking a service provided by a bank as an example with reference to FIGS. 10 and 15.

FIG. 10 is an explanatory diagram (part 3) illustrating a screen example of the conversation screen. The example of FIG. 10 assumes a case where the type information of the information processing terminal 201 corresponds to the specific information processing terminal. For example, a case where the information processing terminal 201 is an information processing terminal such as a digital board installed at a bank is assumed. Furthermore, the operation time zone specified from the operation time zone information of the information processing terminal 201 is assume to be “13:00:00 to 13:59:59 on weekdays”. Furthermore, a case of not considering the user attribute (for example, corresponding to the user attribute “ALL”) is assumed.

In FIG. 10, a conversation screen 1000 is an example of the conversation screen displayed on the display 403 of the information processing terminal 201 when the conversation with the chatbot is started using the talk script corresponding to the operation time zone “13:00:00 to 13:59:59 on weekdays”. In FIG. 10, an avatar av2 is a character representing a bank employee.

The conversation screen 1000 is an operation screen displayed when the user tries to use the information processing terminal 201 just before the end of acceptance of transfer on the day. According to the conversation screen 1000, the user can have a conversation with the chatbot according to the talk script corresponding to the transfer service for which an end time of acceptance on the day is approaching.

For example, by selecting a selection button 1001 by the user's operation input using the input device 404 on the conversation screen 1000, the conversation proceeds to the next conversation, and the service related to transfer/payment can be used. Furthermore, when selecting a selection button 1002 on the conversation screen 1000, a conversation related to teller window/procedure guidance can be performed.

Furthermore, when selecting a selection button 1003 on the conversation screen 1000, a conversation related to introduction of good deal service can be performed. Furthermore, when selecting a selection button 1004 on the conversation screen 1000, a conversation related to services to neighborhood can be performed. Furthermore, when selecting a selection button 1005 on the conversation screen 1000, a conversation related to a region can be performed.

Furthermore, when selecting a language button b1, b2, b3, or b4 on the conversation screen 1000, the language to use can be switched. For example, when the user selects the language button b1, the language to use can be switched from Japanese to English.

Furthermore, a message can be input by selecting a box Bx, and the message input to the box Bx can be transmitted to the chatbot side (information processing device 101) by selecting a transmission button b5, on the conversation screen 1000.

In this way, according to the conversation screen 1000, it is possible to reduce the number of steps to reach the transfer service. In addition, since the options are narrowed down in advance, even when the user feels pressed because the end time of acceptance of the transfer procedure on the day is approaching, the user can proceed with the conversation without hesitating the operation.

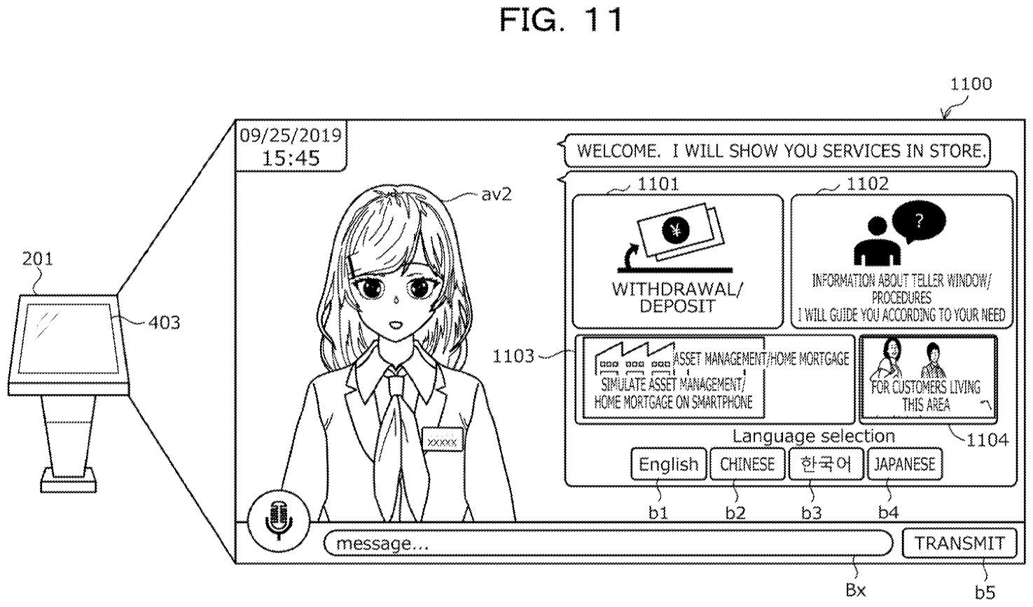

FIG. 11 is an explanatory diagram (part 4) illustrating a screen example of the conversation screen. The example of FIG. 11 assumes a case where the type information of the information processing terminal 201 corresponds to the specific information processing terminal. For example, a case where the information processing terminal 201 is an information processing terminal such as a digital board installed at a bank is assumed. Furthermore, the operation time zone specified from the operation time zone information of the information processing terminal 201 is assume to be “12:00:00 to 17:59:59 on 25th”. Furthermore, a case of not considering the user attribute (for example, corresponding to the user attribute “ALL”) is assumed.

In FIG. 11, a conversation screen 1100 is an example of the conversation screen displayed on the display 403 of the information processing terminal 201 when the conversation with the chatbot is started using the talk script corresponding to the operation time zone “12:00:00 to 17:59:59 on 25th”. In FIG. 11, an avatar av2 is a character representing a bank employee.

The conversation screen 1100 is an operation screen displayed when the user tries to use the information processing terminal 201 in the afternoon of 25th of every month when the number of withdrawals and deposits increases. According to the conversation screen 1100, the user can have a conversation with the chatbot according to the talk script corresponding to a withdrawal or deposit service often selected in the same time zone on the same day.

For example, by selecting a selection button 1101 by the user's operation input using the input device 404 on the conversation screen 1100, the conversation proceeds to the next conversation, and the service related to withdrawal/deposit can be used. Furthermore, when selecting a selection button 1102 on the conversation screen 1100, a conversation related to teller window/procedure guidance can be performed.

Furthermore, when selecting a selection button 1103 on the conversation screen 1100, a conversation related to asset management/home mortgage can be performed. Furthermore, when selecting a selection button 1104 on the conversation screen 1100, a conversation related to a region can be performed.

Furthermore, when selecting the language button b1, b2, b3, or b4 on the conversation screen 1100, the language to use can be switched. For example, when the user selects the language button b1, the language to use can be switched from Japanese to English.

Furthermore, a message can be input by selecting the box Bx, and the message input to the box Bx can be transmitted to the chatbot side (information processing device 101) by selecting the transmission button b5, on the conversation screen 1100.

In this way, according to the conversation screen 1100, it is possible to reduce the number of steps to reach the withdrawal/deposit service that is often used in the afternoon of 25th of every month.

FIG. 12 is an explanatory diagram (part 5) illustrating a screen example of the conversation screen. The example of FIG. 12 assumes a case where the type information of the information processing terminal 201 corresponds to the specific information processing terminal. For example, a case where the information processing terminal 201 is an information processing terminal that the individual user owns or is rented to the user is assumed. Furthermore, a case of not considering the user attribute (for example, corresponding to the user attribute “ALL”) is assumed.

In FIG. 12, a conversation screen 1200 is an example of an operation screen on which the talk script to be applied to the conversation of the chatbot is selectable. In FIG. 12, an avatar av2 is a character representing a bank employee. On the conversation screen 1200, selection buttons 1201 to 1208 for specifying services corresponding to pieces of script information respectively corresponding to the plurality of operation time zones are displayed.

On the conversation screen 1200, the talk script can be selected by selecting one of the selection buttons 1201 to 1208 by the user's operation input using the input device 404.

For example, when selecting the selection button 1201, the user can have a conversation with the chatbot according to the talk script leading to FAQs and services related to withdrawal. This talk script corresponds to, for example, the script information corresponding to the operation time zone “12:00:00 to 18:59:59”.

For example, when selecting the selection button 1202, the user can have a conversation with the chatbot according to the talk script leading to FAQs and services related to deposit. This talk script corresponds to, for example, the script information corresponding to the operation time zone “12:00:00 to 18:59:59”.

For example, when selecting the selection button 1203, the user can have a conversation with the chatbot according to the talk script leading to FAQs and services related to transfer. This talk script corresponds to, for example, the script information corresponding to the operation time zone “13:00:00 to 13:59:59”.

For example, when selecting the selection button 1204, the user can have a conversation with the chatbot according to the talk script leading to FAQs and services related to utility bill payment. This talk script corresponds to, for example, the script information corresponding to the operation time zone “13:00:00 to 13:59:59”.

For example, when selecting the selection button 1205, the user can have a conversation with the chatbot according to the talk script leading to FAQs and services related to opening a new account. This talk script corresponds to, for example, the script information corresponding to the operation time zone “9:00:00 to 14:59:59”.

For example, when selecting the selection button 1206, the user can have a conversation with the chatbot according to the talk script leading to FAQs and services related to yen exchange. This talk script corresponds to, for example, the script information corresponding to the operation time zone “9:00:00 to 14:59:59”.

For example, when selecting the selection button 1207, the user can have a conversation with the chatbot according to the talk script leading to FAQs and services related to asset management/home mortgage. This talk script corresponds to, for example, the script information corresponding to the operation time zone “00:00:00 to 23:59:59”.

For example, when selecting the selection button 1208, the user can have a conversation with the chatbot according to the talk script leading to FAQs and services related to theft, lost, and found. This talk script corresponds to, for example, the script information corresponding to the operation time zone “00:00:00 to 23:59:59”.

Furthermore, when selecting the selection button 1209 on the conversation screen 1200, the content of the selection button can be updated and the selectable talk script can be changed. Furthermore, a message can be input by selecting the box Bx, and the message input to the box Bx can be transmitted to the chatbot side (information processing device 101) by selecting the transmission button b5, on the conversation screen 1200.

In this way, according to the conversation screen 1200, it is possible to allow the user to select the talk script to be applied to the conversation of the chatbot. Furthermore, even if the user is unfamiliar with the operation or uses a service that requires troublesome procedures, it is possible to lead the user to a desired answer or service with as few steps as possible by having the user perform the operation while being supported by the staff of the bank. For example, to use services related to asset management/home mortgage requires a lot of input work and troublesome procedures, but it is possible to smoothly provide the services by having the user perform the operation while being supported by the staff of the bank.

Next, a display example of the operation button capable of switching the conversation by the chatbot to the manned conversation will be described below with reference to FIG. 13.

FIG. 13 is an explanatory diagram (part 6) illustrating a screen example of the conversation screen. The example of FIG. 13 assumes a case where the type information of the information processing terminal 201 corresponds to the specific information processing terminal. For example, a case where the information processing terminal 201 is an information processing terminal such as a digital board installed at a bank is assumed. Furthermore, it is assumed that a user inputs a specific keyword or selects a specific option a plurality of times in a conversation with a chatbot, and as a result, it is determined from the conversation history that a specific condition is satisfied.

In FIG. 13, a conversation screen 1300 is an example of an operation screen on which the talk script to be applied to the conversation of the chatbot is selectable. In FIG. 13, an avatar av2 is a character representing a bank employee. On the conversation screen 1300, selection buttons 1301 to 1308 for specifying services corresponding to pieces of script information respectively corresponding to the plurality of operation time zones and a selection button 1309 are displayed. Note that since the operations when selecting the respective selection buttons 1301 to 1309 are similar to the case described with reference to FIG. 12, description thereof will be omitted.

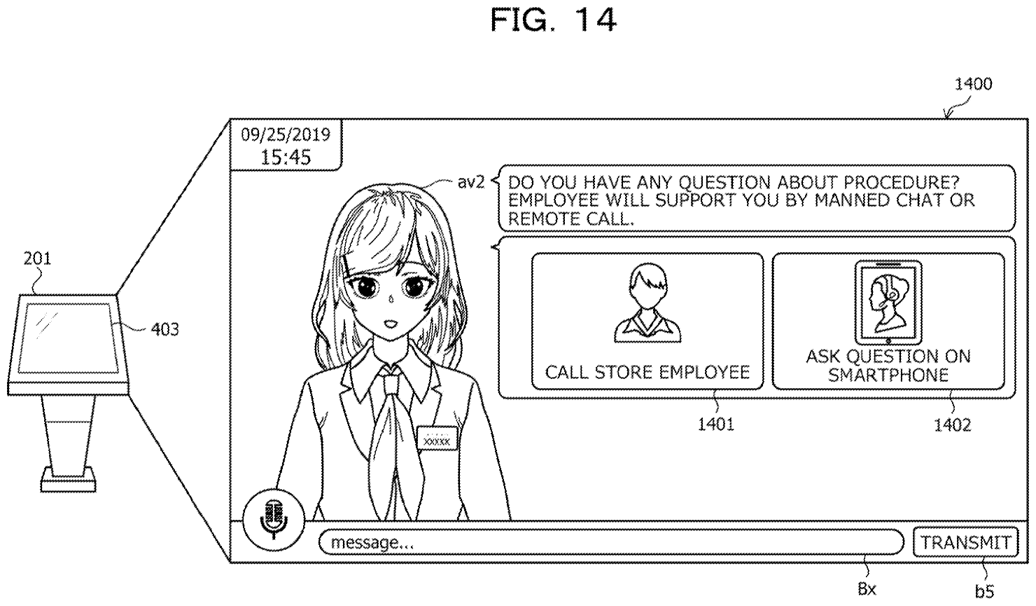

Furthermore, an employee call button 1310 is displayed on the conversation screen 1300. Note that the employee call button 1310 is an example of the operation button that can switch the conversation by the chatbot to the manned conversation. When selecting the employee call button 1310 by the user's operation input using the input device 404 on the conversation screen 1300, a conversation screen 1400 illustrated in FIG. 14 is displayed.

FIG. 14 is an explanatory diagram (part 7) illustrating a screen example of the conversation screen. In FIG. 14, the conversation screen 1400 is an example of an operation screen for switching the conversation by the chatbot to the manned conversation. On the conversation screen 1400, the store employee can be called when selecting a selection button 1401 by the user's operation input using the input device 404.

Thereby, the user can ask questions and use the services while talking to the actual employee.

Furthermore, when selecting a selection button 1402 by the user's operation input on the conversation screen 1400, a manned conversation can be performed using another information processing terminal 201 such as a smartphone that the individual user owns. Specifically, for example, when selecting a selection button 1402, a conversation screen 1500 as illustrated in FIG. 15 is displayed.

FIG. 15 is an explanatory diagram (part 8) illustrating a screen example of the conversation screen. In FIG. 15, the conversation screen 1500 is an example of an operation screen for transferring the conversation with the chatbot in the information processing terminal 201 to another information processing terminal 201.

On the conversation screen 1500, a message 1502 is displayed together with a QR code 1501. The QR code is a registered trademark. The QR code 1501 is a transfer guidance regarding the conversation with the chatbot in the information processing terminal 201. The message 1502 prompts the user to read the QR code 1501.

By reading the QR code 1501 using the another information processing terminal 201 such as a smartphone that the user owns himself/herself, the user can take over the conversation with the chatbot in the information processing terminal 201, in the another information processing terminal 201, for example.

Note that, when selecting a completion button 1503 by the user's operation input on the conversation screen 1500, the conversation with the chatbot can be terminated.

(Transfer of Conversation with Chatbot)

Here, an operation example where the conversation with the chatbot in the information processing terminal 201 is taken over by another information processing terminal 201 will be described.

In the following description, there are some cases where the another information processing terminal 201 that takes over the conversation interrupted in the information processing terminal 201 is described as a “transfer destination terminal 201”. Furthermore, there are some cases where the conversation with the chatbot in the information processing terminal 201 is described as a “first conversation”, and the conversation following the first conversation with the chatbot in the transfer destination terminal 201 is described as a “second conversation”. Furthermore, there are some cases where the script information of the first conversation is described as “first script information”, and the script information applied to the second conversation is described as “second script information”.

Here, the transfer guidance output from the information processing terminal 201 (for example, the QR code 1501 illustrated in FIG. 15) is information by which the transfer information indicating transfer from the first conversation is acquirable by reading the transfer guidance. The transfer information includes information that identifies the first script information, for example, the script ID.

Furthermore, the transfer information may include the information that specifies a point where the first conversation has been interrupted (transfer point), the conversation history of the first conversation, and the like. The transfer point is represented by, for example, information for identifying the talk processing that has interrupted the first conversation, for example, a process name such as TXT-#, SLC-#, or OPT-#. The transfer point may be specified from the conversation history of the first conversation.

For example, the transfer guidance is displayed as a QR code on the display 403 of the information processing terminal 201. At this time, the conversation control unit 703 may cause the information processing terminal 201 to output a message such as “Please read the QR code” (for example, the message 1502 illustrated in FIG. 15) together with the QR code.

Furthermore, the transfer guidance may be output from a non-contact integrated circuit (IC) tag (not illustrated) of the information processing terminal 201. At this time, the conversation control unit 703 may cause a non-contact IC tag portion of the information processing terminal 201 to output a message such as “Please touch here”, for example. As the non-contact IC tag, a near field communication (NFC) tag can be used, for example.

Furthermore, the predetermined condition can be arbitrarily set. For example, the predetermined condition may be a condition of “questioning with an individually owned information processing terminal such as a smartphone”. Furthermore, the predetermined condition may be a condition that “the content to be inquired next is related to the personal information”. The personal information includes name, date of birth, telephone number, address, and the like.

Furthermore, the predetermined condition may be a condition that “the content to be inquired next is related to a store or service”. The store or service may be a specific store or service. Note that information that specifies what kind of content (personal information, store, service, or the like) the inquired content is related to is described in, for example, the script information.

Specifically, for example, the conversation control unit 703 analyzes the conversation content received from the information processing terminal 201 on the basis of the talk script, and determines whether the conversation content satisfies the predetermined condition. Then, in a case of determining that the predetermined condition is satisfied, the conversation control unit 703 causes the information processing terminal 201 to output the transfer guidance of the first conversation.

Note that which talk processing is used to output the transfer guidance of the conversation may be preset in the script information. For example, in the flow of the conversation, it is set in advance so that the transfer guidance is output at timing when the predetermined condition is satisfied.

The transfer destination terminal 201 acquires the transfer information indicating transfer from the first conversation by reading, by a reading unit (not illustrated), the transfer guidance from the conversation output from the information processing terminal 201. In the example illustrated in FIG. 15, the transfer destination terminal 201 acquires the transfer information by reading, by the reading unit (not illustrated), the QR code 1501 displayed on the display 403 of the information processing terminal 201. Furthermore, the transfer destination terminal 201 may acquire the transfer information by receiving, by the reading unit (not illustrated), the transfer guidance output from the non-contact IC tag of the information processing terminal 201.

Furthermore, the transfer destination terminal 201 may acquire the attribute information of the user acquired by the information processing terminal 201 and the operation time zone information of the information processing terminal 201 together with the transfer information. Specifically, for example, the transfer destination terminal 201 may acquire the attribute information of the user and the operation time zone information together with the transfer information by reading the transfer guidance from the first conversation output from the information processing terminal 201.

Furthermore, the transfer destination terminal 201 may communicate with the information processing terminal 201 by short-range wireless communication to acquire the attribute information of the user and the operation time zone information. Furthermore, the transfer destination terminal 201 may have the attribute information of the user input by the user's operation input using the input device 404 of the local terminal, for example.

Note that what kind of attribute information is input is determined in advance, for example. Furthermore, as for the position information and the meteorological information included in the attribute information of the user, the position information indicating a current position of the transfer destination terminal 201 and the meteorological information at the current position of the transfer destination terminal 201 may be reacquired.

The transfer destination terminal 201 transmits the acquired transfer information to the information processing device 101 in response to the acquisition of the transfer information indicating the transfer from the first conversation with the chatbot in the information processing terminal 201. At this time, the transfer destination terminal 201 may transmit the attribute information of the user and the operation time zone information of the information processing terminal 201 to the information processing device 101 together with the transfer information.

Note that the transfer destination terminal 201 may inquire of the user for transmission permission for the transfer information in transmitting the transfer information. In this case, the transfer destination terminal 201 transmits the attribute information of the user and the operation time zone information to the information processing device 101 together with the transfer information in the case of getting the transmission permission.

The communication unit 701 of the information processing device 101 receives the transfer information from the transfer destination terminal 201. Furthermore, the communication unit 701 may receive the operation time zone information of the information processing terminal 201 together with the transfer information. Furthermore, the communication unit 701 may receive the attribute information of the user acquired by the information processing terminal 201 together with the transfer information.

The determination unit 702 determines the second script information to be applied to the second conversation of the chatbot in the transfer destination terminal 201 on the basis of the received transfer information. The second script information may define, for example, a flow of the conversation by the chatbot or may define a flow of the manned conversation.

Specifically, for example, the determination unit 702 may determine the second script information on the basis of the transfer information by referring to the storage unit 710 that stores the script information that defines the flow of the conversation of the chatbot following the first conversation in association with the transfer point of the first script information.

Furthermore, the determination unit 702 may determine the second script information to be applied to the second conversation of the chatbot in the transfer destination terminal 201 on the basis of the received transfer information and operation time zone information. Specifically, for example, the determination unit 702 may determine the second script information on the basis of the transfer information and the operation time zone information by referring to the storage unit 710 that stores the script information that corresponds to each of the plurality of operation time zones and defines the flow of the conversation of the chatbot following the first conversation, in association with the transfer point of the first script information.

Furthermore, the determination unit 702 determines the second script information to be applied to the second conversation of the chatbot in the transfer destination terminal 201 on the basis of the received transfer information, operation time zone information, and attribute information of the user. Specifically, for example, the determination unit 702 may refer to a script transfer table 1600 as illustrated in FIG. 16, and determine the second script information on the basis of the received transfer information, attribute information of the user, and operation time zone information.

Here, stored content of the script transfer table 1600 will be described. The script transfer table 1600 is stored in, for example, a storage device such as the memory 302 or the disk 304 illustrated in FIG. 3.

FIG. 16 is an explanatory diagram illustrating an example of stored content of a script transfer table 1600. In FIG. 16, the script transfer table 1600 has fields for first script, transfer point, user attribute/operation time zone, and second script are set, and script transfer information (for example, script transfer information 1600-1 and 1600-2) is stored as a record by setting information in the respective field.

Here, the first script is the script information of a transfer source. The transfer point is information that specifies a point where the first conversation has been interrupted. The user attribute/operation time zone is a combination of the user attribute and the operation time zone. The second script is the script information of the transfer destination.

For example, the user attribute specified from the attribute information of the user is assumed to be “20s×female”. Furthermore, the operation time zone specified from the operation time zone information is assumed to be “July 22 to August 16”. Furthermore, it is assumed that the transfer information includes the script ID “SP1” that identifies the first script information and the transfer point “OPT-8”. In this case, the determination unit 702 refers to the script transfer table 1600 and determines the script corresponding to the first script “SP1”, the transfer point “OPT-8”, the user attribute “20s×female”, and the operation time zone “July 22 to August 16” as the second script information.

Then, the conversation control unit 703 starts the second conversation following the first conversation with the chatbot in the transfer destination terminal 201 by using the determined second script information. In the example of FIG. 15, the user can have a manned conversation using text communication or the like as the second conversation following the first conversation with the chatbot by reading the QR code 1501 in the transfer destination terminal 201.

(Conversation Control Processing Procedure of Information Processing Device 101)

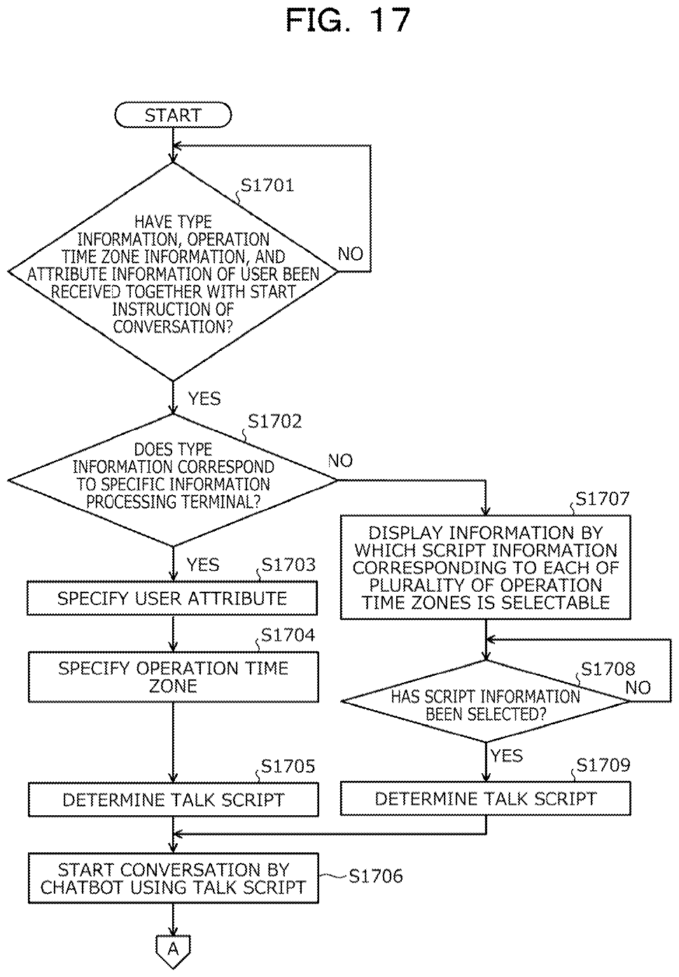

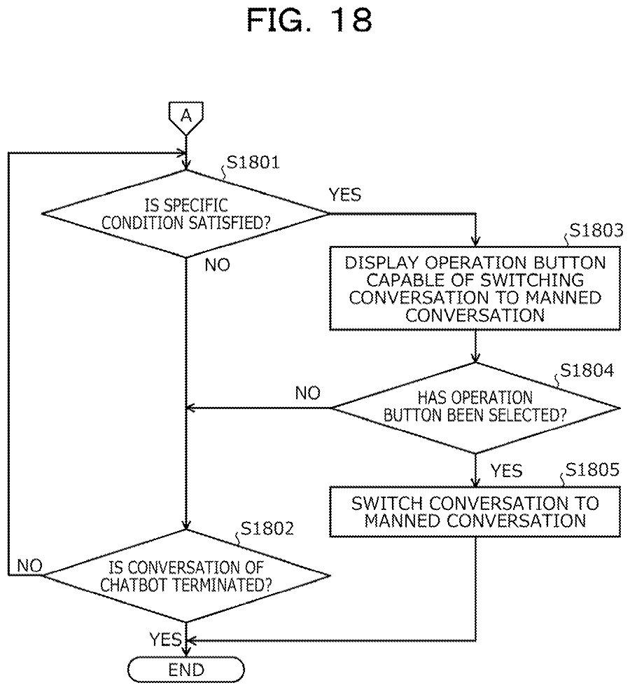

Next, a conversation control processing procedure of the information processing device 101 will be described with reference to FIGS. 17 and 18.

FIGS. 17 and 18 are flowcharts illustrating an example of the conversation control processing procedure of the information processing device 101. In the flowchart of FIG. 17, first, the information processing device 101 determines whether the type information of the information processing terminal 201, the operation time zone information, and the attribute information of the user acquired by the information processing terminal 201 together with the start instruction of the conversation with the chatbot have been received from the information processing terminal 201 (step S1701).

Here, the information processing device 101 waits for receiving the type information of the information processing terminal 201, the operation time zone information, and the attribute information of the user together with the start instruction of the conversation with the chatbot (step S1701: No). Then, in the case of receiving the type information of the information processing terminal 201, the operation time zone information, and the attribute information of the user together with the start instruction of the conversation with the chatbot (step S1701: Yes), the information processing device 101 determines whether the received type information of the information processing terminal 201 corresponds to the specific information processing terminal (step S1702).

Here, in the case where the type information corresponds to the specific information processing terminal (step S1702: Yes), the information processing device 101 specifies the user attribute on the basis of the received attribute information of the user (step S1703). Next, the information processing device 101 specifies the operation time zone in the information processing terminal 201 on the basis of the operation time zone information of the information processing terminal 201 (step S1704).

Next, the information processing device 101 refers to the script table 240 and determines the script information corresponding to the combination of the specified user attribute and operation time zone as the talk script to be applied to the conversation of the chatbot in the information processing terminal 201 (step S1705).

Then, the information processing device 101 starts the conversation with the chatbot in the information processing terminal 201 using the determined talk script (step S1706) and proceeds to step S1801 illustrated in FIG. 18.

Furthermore, in the case where the type information does not correspond to the specific information processing terminal in step S1702 (step S1702: No), the information processing device 101 refers to the script table 240 and displays the information by which the script information corresponding to each of the plurality of operation time zones is selectable on the information processing terminal 201 (step S1707).

Next, the information processing device 101 determines which script information among the pieces of script information respectively corresponding to the plurality of operation time zones has been selected (step S1708). Here, the information processing device 101 waits until the script information is selected (step S1708: No).

Then, in the case where the script information has been selected (step S1708: Yes), the information processing device 101 determines the selected script information as the talk script to be applied to the conversation of the chatbot in the information processing terminal 201 (step S1709) and move onto step S1706.

In the flowchart of FIG. 18, first, the information processing device 101 determines whether a specific condition is satisfied on the basis of the conversation history between the chatbot and the user in the information processing terminal 201 (step S1801). For example, the information processing device 101 determines that the specific condition is satisfied when a specific keyword is input or a specific option is selected a plurality of times.

Here, in the case where the specific condition is not satisfied (step S1801: No), the information processing device 101 determines whether to terminate the conversation of the chatbot in the information processing terminal 201 (step S1802). The conversation of the chatbot is terminated according to the talk script or in response to a user's forced termination operation, for example.

Here, in the case of not terminating the conversation of the chatbot (step S1802: No), the information processing device 101 returns to step S1801. On the other hand, in the case of terminating the conversation of the chatbot (step S1802: Yes), the information processing device 101 terminates the series of processing by the present flowchart.

Furthermore, in the case where specific condition is satisfied in step S1801 (step S1801: Yes), the information processing device 101 displays the operation button capable of switching the conversation by the chatbot to the manned conversation by an operator on the information processing terminal 201 (step S1803).

Next, the information processing device 101 determines whether the operation button capable of switching the conversation to the manned conversation has been selected (step S1804). Here, in the case where the operation button has not been selected (step S1804: No), the information processing device 101 proceeds to step S1802.

On the other hand, in the case where the operation button has been selected (step S1804: Yes), the information processing device 101 connects the information processing terminal 201 and the operator terminal 202, and switches the conversation by the chatbot to the manned conversation by the operator (step S1805). Then, the information processing device 101 ends the series of processing according to the present flowchart.

Thereby, in the case where the type information of the information processing terminal 201 corresponds to the specific information processing terminal, it is possible to control the flow of the conversation of the chatbot in the information processing terminal 201 according to the operation time zone in the information processing terminal 201 and the characteristics (for example, generation, gender, or the like) of the user who uses the information processing terminal 201. Furthermore, in the case where the type information of the information processing terminal 201 does not correspond to the specific information processing terminal, it is possible to allow the user to select the talk script to be applied to the conversation of the chatbot.

Note that, in the above description, the case of receiving the type information of the information processing terminal 201, the operation time zone information, and the attribute information of the user acquired by the information processing terminal 201 in step S1701 has been described as an example. However, the embodiment is not limited to the case. For example, the information processing device 101 does not have to receive the attribute information of the user acquired by the information processing terminal 201. In this case, the information processing device 101 skips step S1703, and determines the script information corresponding to the specified operation time zone as the talk script to be applied to the conversation of the chatbot in the information processing terminal 201 in step S1705.

Furthermore, the information processing device 101 may cause the information processing terminal 201 to output the transfer guidance of the conversation in a case where the conversation content received from the information processing terminal 201 satisfies a predetermined condition after the start of the conversation with the chatbot in the information processing terminal 201. For example, in the case where the operation button for performing the manned conversation is selected using a smartphone or the like that the individual user owns, in step S1804, the information processing terminal 201 may be made to output the transfer guidance of the conversation.

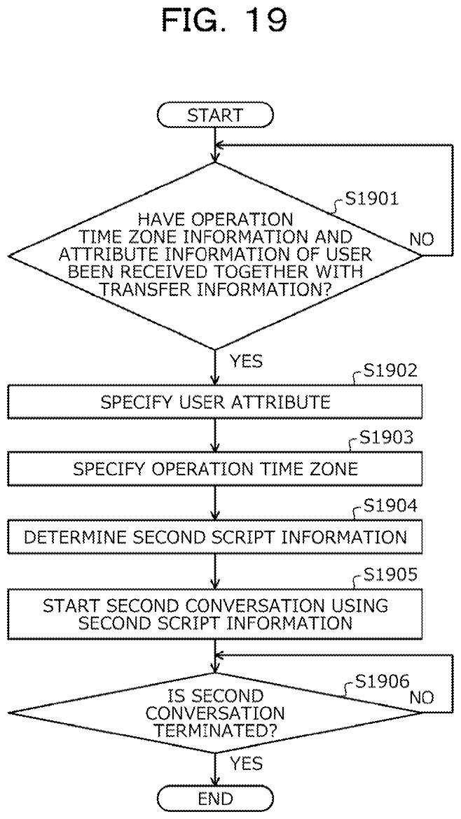

Here, a conversation transfer control processing procedure of the information processing device 101 in the case where the conversation with the chatbot in the information processing terminal 201 is taken over by the transfer destination terminal 201 will be described with reference to FIG. 19.

FIG. 19 is a flowchart illustrating an example of a conversation transfer processing procedure of the information processing device 101. In the flowchart of FIG. 19, first, the information processing device 101 determines whether the operation time zone information of the information processing terminal 201 and the attribute information of the user acquired by the information processing terminal 201 have been received together with the transfer information indicating transfer from the first conversation from the transfer destination terminal 201 (step S1901).

Here, the information processing device 101 waits for receiving the operation time zone information of the information processing terminal 201 and the attribute information of the user together with the transfer information (step S1901: No). Then, in the case of receiving the operation time zone information of the information processing terminal 201 and the attribute information of the user together with the transfer information (step S1901: Yes), the information processing device 101 specifies the user attribute on the basis of the received attribute information of the user (step S1902).

Next, the information processing device 101 specifies the operation time zone in the information processing terminal 201 on the basis of the received operation time zone information of the information processing terminal 201 (step S1903). Next, the information processing device 101 refers to the script transfer table 1600, and determines the second script information to be applied to the conversation of the chatbot in the transfer destination terminal 201 on the basis of the received transfer information and the specified user attribute and operation time zone (step S1904).

Then, the information processing device 101 starts the second conversation following the first conversation with the chatbot in the transfer destination terminal 201 using the determined second script information (step S1905). Next, the information processing device 101 determines whether to terminate the second conversation of the chatbot in the transfer destination terminal 201 (step S1906). The second conversation is terminated according to the second script information or in response to the user's forced termination operation, for example.

Here, the information processing device 101 waits for the termination of the second conversation (step S1906: No). Then, in the case of terminating the second conversation (step S1906: Yes), the information processing device 101 terminates the series of processing by the present flowchart.

Thereby, it is possible to transfer the conversation in the open chat that has been interrupted at the timing of, for example, switching to the manned conversation using a smartphone of the user or the like, or occurrence of an inquiry related to the personal information, to the conversation in the closed chat.

As described above, according to the information processing device 101 of the embodiment, it is possible to receive the start instruction of the conversation with the chatbot from the information processing terminal 201 that the user uses, and receive the type information of the information processing terminal 201 and the information that specifies the operation time zone in the information processing terminal 201. Furthermore, according to the information processing device 101, in the case where the type information of the information processing terminal 201 corresponds to the specific information processing terminal, it is possible to start the conversation with the chatbot in the information processing terminal 201 using the script information determined on the basis of the information that specifies the received operation time zone by reference to the storage unit 710 that stores the script information that corresponds to each of the plurality of operation time zones and defines the processing regarding the conversation of the chatbot, in response to the start instruction of the conversation with the chatbot. The operation time zone is divided using at least either the date or the time, for example. The specific information processing terminal is, for example, a stationary information processing terminal installed in a highly public place such as a station or an airport, a store, a commercial facility, or the like.

Thereby, in the case where the type information of the information processing terminal 201 corresponds to the specific information processing terminal, it is possible to dynamically change the content and flow of the conversation of the chatbot in the information processing terminal 201 according to the operation time zone in the information processing terminal 201. For example, it becomes possible to narrow down the options to be displayed at once or reduce the hierarchy of scripts in consideration of changes in the frequently used FAQs and services depending on differences in the time zone, changes in services to be presented with priority in relation to available time, and the like. For this reason, when the user uses the information processing terminal 201 (for example, a digital board) installed in a facility such as an airport or a station, or a store such as a bank, it is possible to reduce the number of steps to reach the desired FAQs or services.

Furthermore, according to the information processing device 101, in the case where the type information of the information processing terminal 201 does not correspond to the specific information processing terminal, it is possible to display information by which at least one of the pieces of script information respectively corresponding to the plurality of operation time zones is selectable on the information processing terminal 201, and start the conversation with the chatbot in the information processing terminal 201, using the selected script information.

Thereby, in the case where the type information of the information processing terminal 201 does not correspond to the specific information processing terminal, it is possible to allow the user to select a talk script to be applied to the conversation of the chatbot. Furthermore, even if the user is unfamiliar with the operation or uses a service that requires troublesome procedures, it is possible to lead the user to a desired answer or service with as few steps as possible by having the user perform the operation while being supported by the staff such as an airport employee or a bank employee.

Furthermore, according to the information processing device 101, in the case where the attribute information of the user acquired by the information processing terminal 201 is further received and the type information of the information processing terminal 201 corresponds to the specific information processing terminal, it is possible to determine the script information on the basis of the received attribute information of the user and the information that specifies the operation time zone by reference to the storage unit 710 that stores the script information corresponding to each of a plurality of combinations between the user attribute and the operation time zone. Then, according to the information processing device 101, it is possible to start the conversation with the chatbot in the information processing terminal 201, using the determined script information.

Thereby, in the case where the type information of the information processing terminal 201 corresponds to the specific information processing terminal, it is possible to dynamically change the content and flow of the conversation of the chatbot in the information processing terminal 201 according to the operation time zone in the information processing terminal 201 and the characteristics of the user who uses the information processing terminal 201. For example, it is possible to narrow down the options to be displayed at one time or reduce the layers of hierarchy of scripts by considering that frequently selected FAQs and services change depending on the generation or gender. Furthermore, it is possible to narrow down the options to be displayed at one time or reduce the layers of hierarchy of scripts by considering that frequently selected FAQs and services change depending on a difference in place or weather, the presence or absence of a wheelchair, the presence or absence of a companion, or the like.

Furthermore, according to the information processing device 101, it is possible to display the operation button capable of switching the conversation by the chatbot to the manned conversation in the case where a specific condition is satisfied on the basis of the conversation history with the chatbot in the information processing terminal 201.

Thereby, it becomes possible to take appropriate makes by switching the conversation by the chatbot to the manned conversation in the case where the user is not able to reach the desired FAQs, services in the conversation with the chatbot, or the like. Furthermore, it is possible to prevent easy selection of the manned conversations by displaying the operation button capable of switching the conversation to the manned conversation in the case where a specific condition is satisfied instead of displaying the operation button from the beginning.

Furthermore, according to the information processing device 101, it is possible to start the second conversation following the first conversation with the chatbot in the transfer destination terminal 201 on the basis of the transfer information and the information that specifies the operation time zone in the case of receiving the information that specifies the operation time zone in the information processing terminal 201 together with the transfer information indicating transfer from the first conversation from the transfer destination terminal 201 after the start of the first conversation with the chatbot in the information processing terminal 201.

Thereby, it is possible to transfer the conversation with the chatbot from the open chat to the closed chat. For example, it is possible to transfer the conversation in the open chat that has been interrupted at the timing of, for example, switching the conversation to the manned conversation using a smartphone of the user or the like, or occurrence of an inquiry related to the personal information, to the conversation in the closed chat.

From the above, according to the information processing device 101 and the conversation control system 200 of the embodiment, it is possible to switch determination of the talk script to be applied to the conversation of the chatbot between automatic determination from the operation time zone in the information processing terminal 201 according to the type information of the information processing terminal 201 and the selection by the user. Thereby, it is possible to smoothly provide the service using the chatbot while suppressing a withdrawal from a chat by reducing the number of steps to obtain a desired FAQ or use a desired service. As a result, it is possible to improve accessibility of the FAQ system using the chatbot, which in turn can lead to the use of stores and services.

Note that the conversation control method described in the present embodiments may be implemented by a computer such as a personal computer or a workstation executing a prepared program. The present conversation control program is recorded on a computer-readable recording medium such as a hard disk, flexible disk, compact disk read only memory (CD-ROM), digital versatile disc (DVD), or USB memory, and is read from the recording medium to be executed by the computer. Furthermore, the present conversation control program may be distributed via a network such as the Internet.

Furthermore, the information processing device 101 described in the present embodiment may also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a conversation control program for causing a computer to execute processing comprising:
receiving a start instruction of a conversation with a chatbot from an information processing terminal used by a user, and receiving type information of the information processing terminal and information that specifies an operation time zone in the information processing terminal;
in a case where the type information corresponds to a specific information processing terminal, referring to a storage unit that stores script information that corresponds to each of a plurality of operation time zones and defines processing regarding the conversation of the chatbot, and starting the conversation with the chatbot in the information processing terminal by using the script information determined on the basis of the received information that specifies an operation time zone; and
in a case where the type information does not correspond to the specific information processing terminal, displaying information by which at least one of pieces of the script information that respectively corresponds to the plurality of operation time zones is selectable on the information processing terminal, and starting the conversation with the chatbot in the information processing terminal by using the selected script information, in response to the start instruction of the conversation with the chatbot.

2. The non-transitory computer-readable recording medium according to claim 1, wherein the operation time zone is divided by using at least one of date or time.

3. The non-transitory computer-readable recording medium according to claim 1, wherein
the storage unit stores the script information that corresponds to each of a plurality of combinations of user attributes and operation time zones,
the processing of receiving includes
further receiving attribute information of the user acquired by the information processing terminal, and
the processing of starting the conversation includes,
in the case where the type information corresponds to the specific information processing terminal, determining the script information on the basis of the received attribute information of the user and the received information that specifies an operation time zone by reference to the storage unit, and starting the conversation with the chatbot in the information processing terminal by using the determined script information.

4. The non-transitory computer-readable recording medium according to claim 1, wherein the specific information processing terminal is a stationary information processing terminal installed in a highly public facility or store.

5. The non-transitory computer-readable recording medium according to claim 1, wherein the script information is script information that describes processing of displaying an operation button capable of switching the conversation by the chatbot to a manned conversation in a case where a specific condition is satisfied on the basis of a conversation history of the chatbot.

6. The non-transitory computer-readable recording medium according to claim 3, wherein the user attribute is classified on the basis of at least one of generation or gender.

7. The non-transitory computer-readable recording medium according to claim 1, for causing the computer to execute processing comprising:
in a case of receiving the information that specifies an operation time zone together with transfer information that indicates transfer from the conversation from another information processing terminal after starting the conversation with the chatbot in the information processing terminal, starting a second conversation that follows the conversation with the chatbot in the another information processing terminal on the basis of the transfer information and the information that specifies an operation time zone.

8. A conversation control method comprising:
receiving, by a computer, a start instruction of a conversation with a chatbot from an information processing terminal used by a user, and receiving type information of the information processing terminal and information that specifies an operation time zone in the information processing terminal;
in a case where the type information corresponds to a specific information processing terminal, referring to a storage unit that stores script information that corresponds to each of a plurality of operation time zones and defines processing regarding the conversation of the chatbot, and starting the conversation with the chatbot in the information processing terminal by using the script information determined on the basis of the received information that specifies an operation time zone; and
in a case where the type information does not correspond to the specific information processing terminal, displaying information by which at least one of pieces of the script information that respectively corresponds to the plurality of operation time zones is selectable on the information processing terminal, and starting the conversation with the chatbot in the information processing terminal by using the selected script information, in response to the start instruction of the conversation with the chatbot.

9. An information processing device comprising:
a memory; and
a processor coupled to the memory and configured to:
receive an information processing terminal used by a user, and receiving type information of the information processing terminal and information that specifies an operation time zone in the information processing terminal;
in a case where the type information corresponds to a specific information processing terminal, refer to a storage unit that stores script information that corresponds to each of a plurality of operation time zones and defines processing regarding the conversation of the chatbot, and start the conversation with the chatbot in the information processing terminal by using the script information determined on the basis of the received information that specifies an operation time zone; and
in a case where the type information does not correspond to the specific information processing terminal, display information by which at least one of pieces of the script information that respectively corresponds to the plurality of operation time zones is selectable on the information processing terminal, and start the conversation with the chatbot in the information processing terminal by using the selected script information, in response to the start instruction of the conversation with the chatbot.
